(19) United States
(12) Patent Application Publication
(10) Pub. No.: US 2026/0222751 A1
(43) Pub. Date: Jul. 30, 2026

(54) On-Head Detection and/or Hearable-Adjustment Detection using Active Acoustic Sensing

(71) Applicant: Google LLC, Mountain View, CA (US)

(72) Inventors: Xiaoran Fan, Irvine, CA (US); Trausti Thormundsson, Irvine, CA (US)

(73) Assignee: Google LLC, Mountain View, CA (US)

(21) Appl. No.: 19/147,976

(22) PCT Filed: Mar. 15, 2024
(86) PCT No.: PCT/US2024/020238

§ 371 Date: Jul. 14, 2025

Related U.S. Application Data
(60) Provisional application No. 63/490,657, filed on Mar. 16, 2023.

(51) Int. Cl. H04R 29/00; H04R 1/10; H04R 3/12; H04R 25/00

(52) U.S. Cl. CPC H04R 29/001; H04R 1/1016; H04R 1/1041; H04R 3/12; H04R 25/43; H04R 25/305; H04R 2420/01; H04R 2460/01; H04R 2460/03

(57) ABSTRACT

Techniques and apparatuses are described for performing on-head detection and/or hearable-adjustment detection using active acoustic sensing. A hearable, such as an earbud, is capable of performing audioplethysmography. Audioplethysmography is an active acoustic method capable of sensing subtle physiologically-related changes observable at a user's outer and middle ear. The hearable forms at least a partial seal in or around the user's outer ear, which enables formation of an acoustic circuit involving the seal, the hearable, an ear canal, and an ear drum. By transmitting and receiving acoustic signals, the hearable can recognize changes in the acoustic circuit to perform aspects of on-head detection and/or hearable-adjustment detection. The size, cost, and power usage of the hearable can help make these features accessible to a larger group of people and improve the user experience with hearables.

### BACKGROUND

Wireless technology has become prevalent in everyday life, making communication and data readily accessible to users. One type of wireless technology are wireless hearables, examples of which include wireless earbuds and wireless headphones. Wireless hearables have allowed users freedom of movement while listening to audio content from music, audio books, podcasts, and videos. With the prevalence of wireless hearables, there is a market for adding additional features to existing hearables without introducing hardware changes.

### SUMMARY

Techniques and apparatuses are described for performing on-head detection and/or hearable-adjustment detection using active acoustic sensing. A hearable, such as an earbud, is capable of performing a novel physiological monitoring process termed herein audioplethysmography. Audioplethysmography is an active acoustic method capable of sensing subtle changes observable at a user's outer and middle ear. Instead of relying on other auxiliary sensors, such as optical or electrical sensors, audioplethysmography involves transmitting and receiving acoustic signals that at least partially propagate within a user's ear canal. To perform audioplethysmography, the hearable forms at least a partial seal in or around the user's outer ear. This seal enables formation of an acoustic circuit, which includes the seal, the hearable, the ear canal, and an ear drum of the ear. By transmitting and receiving acoustic signals, the hearable can recognize changes in the acoustic circuit to perform aspects of on-head detection and/or hearable-adjustment detection. In various implementations, the hearable can control an operation of a computing device based on the on-head detection and/or the hearable-adjustment detection. In addition to being relatively unobtrusive, some hearables can be configured to support on-head detection and/or hearable-adjustment detection without the need for additional hardware. As such, the size, cost, and power usage of the hearable can help make these features accessible to a larger group of people and improve the user experience with hearables.

Aspects described below include a method for performing on-head detection and/or hearable-adjustment detection using active acoustic sensing. The method includes transmitting, by a hearable and during a first time period, an acoustic transmit signal that propagates within at least a portion of an ear canal of a user. The method also includes receiving, by the hearable and during the first time period, an acoustic receive signal. The acoustic receive signal represents a version of the acoustic transmit signal with one or more characteristics modified based on the propagation within the ear canal. The method additionally includes determining, based on the acoustic receive signal, at least one of the following: that the hearable is worn by the user during the first time period and/or that the user is repositioning the hearable within their ear during at least a portion of the first time period.

The method can optionally include generating a control signal that controls an operation of a device based on the on-head detection and/or based on the hearable-adjustment detection. The device may comprise at least one of the hearable or a computing device that is coupled to the hearable.

Aspects described below include a computer-readable storage medium comprising instructions that, responsive to execution by a processor, cause the hearable to perform any one of the methods described herein. In one example, the at least one processor may be part of a device of which an operation is controlled based on the on-head detection and/or the hearable-adjustment detection or the at least one processor may be part of the hearable coupled to the device of which an operation is controlled based on the on-head detection and/or the hearable-adjustment detection.

Aspects described below include a system with at least one transducer and at least one processor. The system is configured to perform, using the at least one transducer and the at least one processor, any one of the methods described herein. For example, the at least one transducer may be configured to transmit the acoustic transmit signal and/or to receive the acoustic receive signal.

Aspects described below include a system with means for performing on-head detection and/or the hearable-adjustment detection using active acoustic sensing.

### BRIEF DESCRIPTION OF DRAWINGS

Apparatuses for and techniques that perform on-head detection and/or the hearable-adjustment detection using active acoustic sensing are described with reference to the following drawings. The same numbers are used throughout the drawings to reference like features and components:

FIG. 1 illustrates an example environment in which active acoustic sensing can be implemented;

FIG. 2-1 illustrates example environments for performing on-head detection using active acoustic sensing;

FIG. 2-2 illustrates example environments for performing hearable-adjustment detection using active acoustic sensing;

FIG. 3 illustrates example components of a computing device;

FIG. 4 illustrates example components of a hearable;

FIG. 5 illustrates example operations of two hearables;

FIG. 6 illustrates an example implementation of a hearable capable of performing on-head detection and/or the hearable-adjustment detection using active acoustic sensing;

FIG. 7 illustrates an example implementation of a measurement module for performing aspects of on-head detection using active acoustic sensing;

FIG. 8 illustrates an example scheme implemented by a hearable for performing aspects of on-head detection using active acoustic sensing;

FIG. 9 illustrates example pre-processed signals for performing aspects of on-head detection using active acoustic sensing;

FIG. 10 illustrates other example pre-processed signals for performing aspects of on-head detection using active acoustic sensing;

FIG. 11 illustrates an example scheme for performing aspects of hearable-adjustment detection using active acoustic sensing;

FIG. 12 illustrates example pre-processed signals for performing aspects of hearable-adjustment detection using active acoustic sensing;

FIG. 13 illustrates other example pre-processed signals for performing aspects of hearable-adjustment detection using active acoustic sensing;

FIG. 14 illustrates a first example method for performing aspects of on-head detection and/or hearable-adjustment detection using active acoustic sensing;

FIG. 15 illustrates a second example method for performing aspects of on-head detection and/or hearable-adjustment detection using active acoustic sensing; and

FIG. 16 illustrates an example computing system embodying, or in which techniques may be implemented that enable use of, on-head detection and/or the hearable-adjustment detection using active acoustic sensing.

### DETAILED DESCRIPTION

Wireless technology has become prevalent in everyday life, making communication and data readily accessible to users. One type of wireless technology are wireless hearables, examples of which include wireless earbuds and wireless headphones. Wireless hearables have allowed users freedom of movement while listening to audio content from music, audio books, podcasts, and videos.

To improve aesthetics and reduce encumbrance, it can be desirable to design hearables with smaller sizes. As space becomes limited, it can be challenging to integrate additional components, such as an infrared sensor or an inertial measurement unit (IMU), within the hearables. Some hearable designs can forego these additional components to meet a target size at the expense of lacking features that provide additional convenience to the user, such as on-head detection and/or hearable-adjustment detection. With the prevalence of hearables, there is a market for adding additional features to existing hearables to improve the user experience without introducing hardware changes.

Provided according to one or more preferred implementations is a hearable, such as an earbud, that is capable of performing a novel physiological monitoring process termed herein audioplethysmography. Audioplethysmography is an active acoustic method capable of sensing subtle physiologically-related changes observable at a user's outer and middle ear. Instead of relying on other auxiliary sensors, such as optical or electrical sensors, audioplethysmography involves transmitting and receiving acoustic signals that at least partially propagate within a user's ear canal. To perform audioplethysmography, the hearable forms at least a partial seal in or around the user's outer ear. This seal enables formation of an acoustic circuit, which includes the seal, the hearable, the ear canal, and an ear drum of the ear. By transmitting and receiving acoustic signals, the hearable can recognize changes in the acoustic circuit that indicate the hearable is being worn by the user and/or that indicate the user is adjusting the hearable. In this manner, active acoustic sensing enables the hearable perform on-head detection and/or hearable-adjustment detection.

### Operating Environment

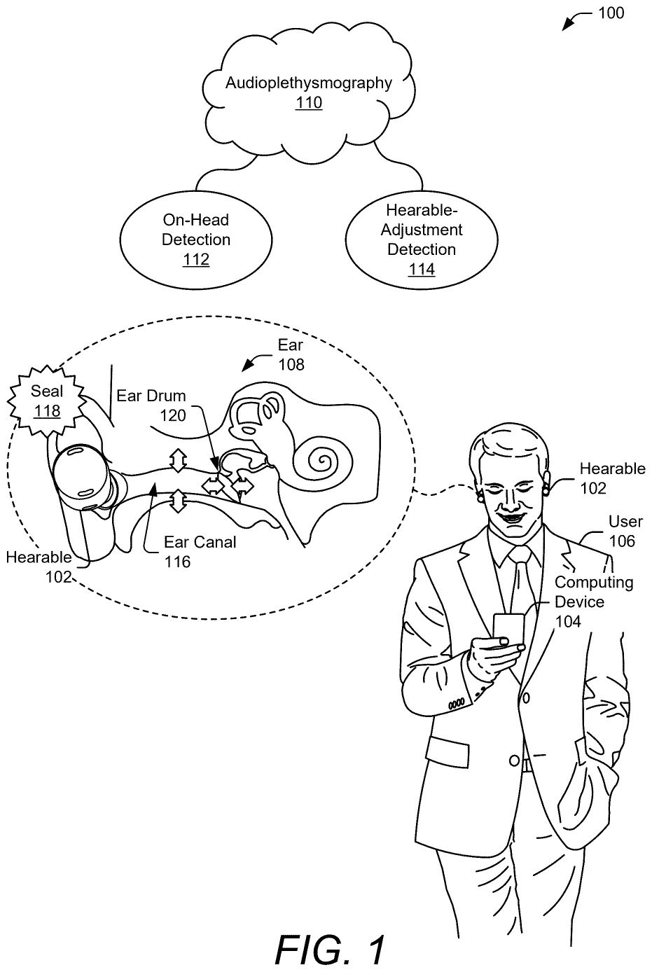

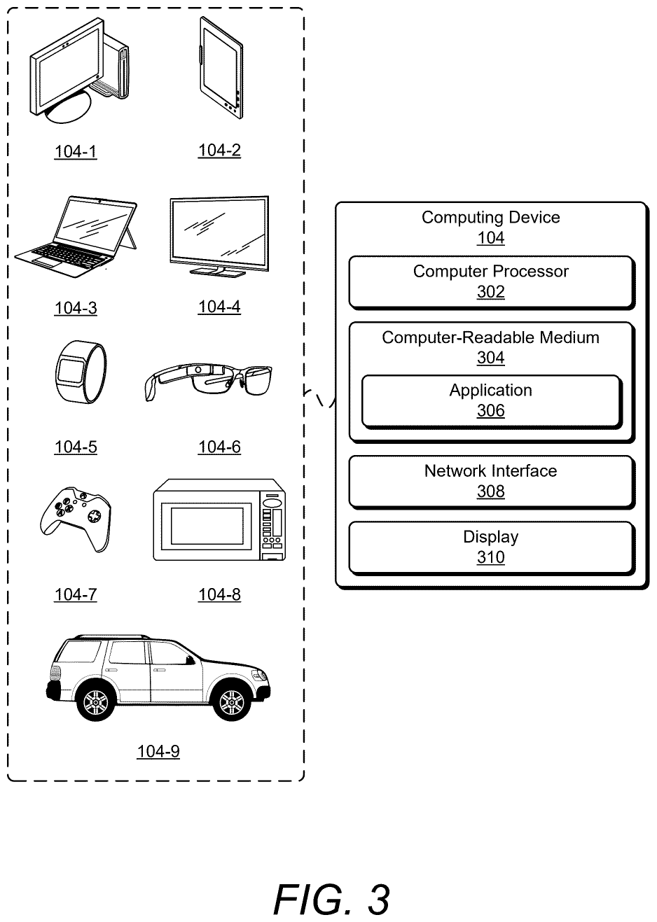

FIG. 1 is an illustration of an example environment 100 in which active acoustic sensing can be implemented. In the example environment 100, a hearable 102 is connected to a computing device 104 using a physical or wireless interface. The hearable 102 is a device that can play audible content provided by the computing device 104 and direct the audible content into a user 106's ear 108. In this example, the hearable 102 operates together with the computing device 104. In other examples, the hearable 102 can operate or be implemented as a stand-alone device. Although depicted as a smartphone, the computing device 104 can include other types of devices, including those described with respect to FIG. 3.

The hearable 102 is capable of performing audioplethysmography 110, which is an active acoustic method of sensing that occurs at the ear 108. The hearable 102 can perform this sensing without the use of other auxiliary sensors, such as an optical sensor or an electrical sensor. Through audioplethysmography 110, the hearable 102 can perform on-head detection 112 and/or hearable-adjustment detection 114. Additionally, the hearable 102 can also use audioplethysmography 110 to perform biometric monitoring.

The term “on-head” detection (or automatic head detection) generally describes an ability of the hearable 102 to determine whether or not it is being worn by the user 106. More specifically, on-head detection 112 represents an ability of the hearable 102 to determine whether or not it is positioned on a head (or arranged at an ear 108) of the user 106. On-head detection 112 can also be referred to as “in-ear” detection, particularly with respect to earbuds that are inserted into a user 106's ear canal 116. In general, on-head detection 112 determines whether or not the hearable 102 is proximate to (arranged at) an ear 108 of the user 106. The term “proximate” can refer to the hearable 102 being sufficiently close to the ear 108 to perform aspects of audioplethsymography 110 (e.g., sufficiently close to direct acoustic signals into the ear 108). Based on the results of the on-head detection 112, the hearable 102 can control an operation of the computing device 104. Additionally or alternatively, the hearable 102 can control its own operation based on the on-head detection 112. Either control feature can be used to improve power management and/or improve the user experience.

Hearable-adjustment detection 114 generally describes an ability of the hearable 102 to determine whether or not it is being repositioned (e.g., moved or re-adjusted) by the user 106. Hearable-adjustment detection 114 can occur while the hearable 102 is being worn by the user 106. Various movements that reposition the hearable 102 relative to the ear 108 of the user 106. A first example movement involves rotating or twisting the hearable 102, which changes an orientation of the hearable 102 relative to the ear 108. A second example movement involves pushing or pulling the hearable 102 into or out of the ear 108, which changes an insertion depth of the hearable 102 within the ear 108. Using audioplethysmography 110, the hearable 102 can also distinguish between movements of the hearable 102 that are intentionally caused by the user 106 or movements that are indirectly caused by the user 106 performing another activity, such as walking or running.

Some hearable 102 can provide other features in addition to audioplethsymography 110. Example features can include rendering (e.g., playing) audible content, providing active noise cancellation, and/or providing a transparency mode. The transparency mode enables sounds from an external environment to be rendered for the user 106. In this manner, the transparency mode enables the hearable 102 to function as a hearing aid. While active noise cancellation can significantly attenuate sounds from the external environment, the transparency mode allows sounds from the external environment to pass to the user 106's ear 108. In some cases, the transparency mode can further amplify these sounds to assist with a hearing impairment.

To perform on-head detection 112 and/or hearable-adjustment detection 114, the hearable 102 uses audioplethysmography 110 to detect subtle pressure waves that propagate to the user 106's ear canal 116. These pressure waves modify characteristics of acoustic signals that are transmitted and received by the hearable 102 and propagate through the ear canal 116. As the user 106 wears the hearable 102, the ear canal 116 deforms at least in part due to biometrics of the user 106 (e.g., heart rate, respiration rate, and/or blood pressure). Additionally or alternatively, characteristics of the acoustic signals can be modified as the user 106 adjusts a position of the hearable 102 in (or on) their ear 108.

To use audioplethysmography 110, the user 106 positions the hearable 102 in a manner that creates at least a partial seal 118 around or in the ear 108. Some parts of the ear 108 are shown in FIG. 1, including the ear canal 116 and an ear drum 120 (or tympanic membrane). Due to the seal 118, the hearable 102, the ear canal 116, and the ear drum 120 couple together to form an acoustic circuit. Audioplethysmography 110 involves, at least in part, measuring properties associated with this acoustic circuit. The properties of the acoustic circuit can change due to a variety of different situations or actions.

For example, consider a change that occurs in a physical structure of the ear 108. Example changes to the physical structure include a change in a geometric shape of the ear canal 116 and/or a change in a volume of the ear canal 116. This change can be caused, at least in part, by a pressure wave that is formed by the user 106's heartbeat and/or breathing. For instance, the tissue around the ear canal 116 and the ear drum 120 itself are slightly “squeezed” due to the pressure wave. This squeeze causes a volume of the ear canal 116 to be slightly reduced. As the squeezing subsides, the volume of the ear canal 116 is slightly increased. The increasing and decreasing of the volume of the ear canal 116 is indicated by the arrows in FIG. 1. The physical changes within the ear 108 can modulate an amplitude, frequency, and/or phase of an acoustic signal that propagates through the ear canal 116.

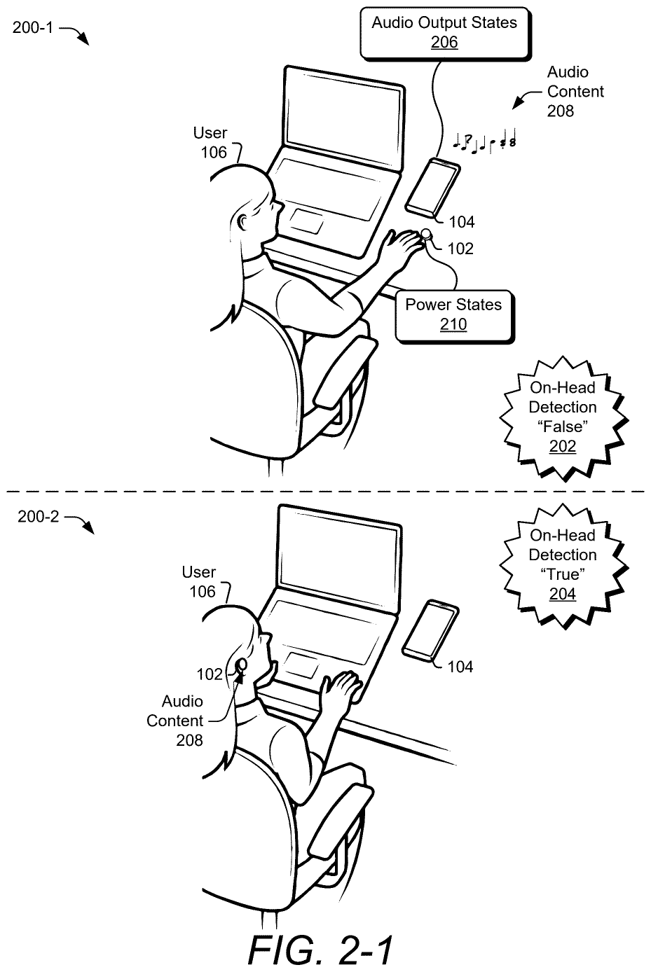

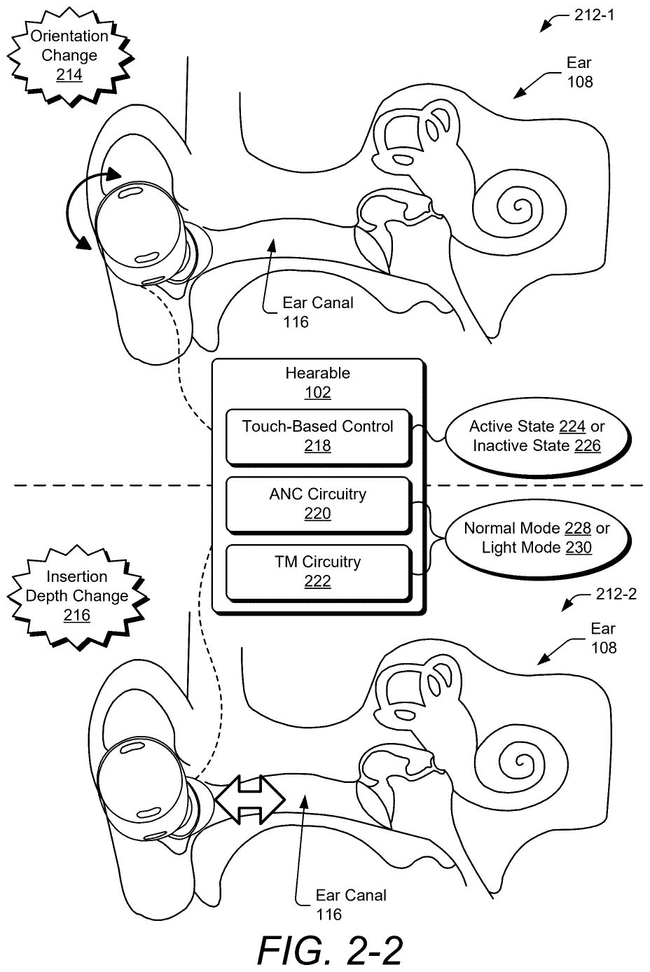

The techniques for audioplethysmography 110 can be performed while the hearable 102 is rendering (e.g., playing or transmitting) audible content and/or while the user 106 is actively moving or performing an activity (e.g., walking or running). As such, active acoustic sensing enables the hearable 102 to perform on-head detection 112 and/or hearable-adjustment detection 114 in a variety of different situations. In some implementations, the hearable 102 can continuously perform audioplethysmography 110 while powered on. In this way, the hearable 102 can perform on-head detection 112 and/or hearable-adjustment detection 114 in a continuous manner. On-head detection 112 and hearable-adjustment detection 114 are further described with respect to FIGS. 2-1 and 2-2, respectively.

FIG. 2-1 illustrates example environments 200-1 and 200-2 for performing aspects of on-head detection 112 using active acoustic sensing. In the environment 200-1, the hearable 102 is positioned on a desk and the user 106 is not wearing the hearable 102. With audioplethysmography 110, the hearable 102 performs on-head detection 112 and determines that it is not being worn by the user 106. As such, the hearable 102 determines that on-head detection is “false,” as indicated at 202.

In the environment 200-2, the user 106 wears the hearable 102. With audioplethysmography 110, the hearable 102 performs on-head detection 112 and determines that it is being worn by the user 106. Accordingly, the hearable 102 determines that on-head detection is “true,” as indicated at 204. With on-head detection 112, the hearable 102 can control the computing device 104 and/or another operation performed by the hearable 102 based on whether on-head detection 112 is true 204 or false 202.

Consider an example in which the hearable 102 controls an operation of the computing device 104 based on the on-head detection 112. In this example, the computing device 104 has different audio output states 206. A first state causes the computing device 104 to render audio content 208 via its own speaker. A second state causes the computing device 104 to communicate or provide audio content 208 to the hearable 102 so that the hearable 102 can render the audio content 208 via its speaker. In the environment 200-1, the on-head detection 112 causes the computing device 104 to be in (or remain in) the first state so that the user 106 can hear the audio content 208 while not wearing the hearable 102. In the environment 200-2, however, the on-head detection 112 causes the computing device 104 to transition to the second state so that the user 106 can listen to the audio content 208 via the hearable 102.

In another example, the hearable 102 controls itself based on the on-head detection 112. In this example, the hearable 102 has different power states 210, such as a low-power state and a high-power state. The low-power state enables the hearable 102 to conserve battery when it is not in use. Various circuits (e.g., sensors, components, and/or operations) can be placed in a standby or powered-down state in accordance with the low-power state of the hearable 102. Example circuits can include those associated with active noise cancellation, a transparency mode, speech processing, and/or hearable-adjustment detection 114. In accordance with the high-power state of the hearable 102, these circuits can be placed in an active or powered-up state. Generally speaking, the low-power state consumes less power than the high-power state. In the environment 200-1, the on-head detection 112 causes the hearable 102 to be in the low-power state to conserve power. In the environment 200-2, however, the on-head detection 112 causes the hearable 102 to transition to the high-power state. By transitioning between the low-power state and the high-power state based on the on-head detection 112, the hearable 102 can conserve power and extend its use.

Other aspects of the computing device 104 and/or the hearable 102 can also be controlled based on on-head detection 112. For example, the hearable 102 can use on-head detection 112 to control the rendering of the audio content. The hearable 102 can initiate the rendering of the audio content 208 based on a determination that on-head detection 112 is true 204, as in the environment 200-2. Alternatively, the hearable 102 can halt (e.g., pause) the rendering of the audio content 208 based on the determination that on-head detection 112 is false 202, as in the environment 200-1. In this way, the hearable 102 can automatically pause the audio content 208 based on the user 106 removing the hearable 102 and can automatically resume the rendering of the audio content 208 based on the user 106 wearing the hearable 102.

To perform on-head detection 112, the hearable 102 uses audioplethysmography 110 to detect one or more biometrics (e.g., one or more physiological metrics) of the user 106. Example biometrics can include the user 106's heart rate, respiration rate, blood pressure, body temperature, carbon dioxide level (within the ear canal 116), and so forth. The biometrics can be readily detected when the hearable 102 is proximate to the user 106's ear 108. The term “proximate” refers to the hearable 102 being positioned on (or arranged at) the user 106's ear 108, as in the case of a headphones, or the hearable 102 being inserted partially within the user 106's ear 108, as in the case of earbuds. By detecting and relying on biometrics to determine on-head detection 112, active acoustic sensing is less susceptible to generating false positives associated with on-head detection 112 while the hearable 102 is resting on a flat surface, while the hearable 102 is being held by the user 106, or while the hearable 102 is placed in the user 106's pocket. Compare this to other on-head detection techniques, such as those that utilize infrared technology.

With infrared technology, another hearable can directly measure a distance between the hearable and the user. It can be challenging, however, for some infrared sensors to determine whether the object it detects corresponds to the user's ear or another nearby object. In some situations, this hearable can incorrectly determine that on-head detection is true while positioned on a substantially flat surface, such as a desk or table, or while held in the user 106's hand or placed in the user 106's pocket. Size constraints and/or cost constraints can also make it challenging to integrate an infrared sensor into a hearable.

To address these challenges, techniques for performing on-head detection 112 using active acoustic sensing are described. In particular, the hearable 102 performs audioplethysmography 110 to measure at least one biometric of the user 106. If the biometric is in a valid range, the hearable 102 determines that on-head detection 112 is “true.” If the biometric is outside of the valid range (e.g., is invalid) or not able to be measured, the hearable 102 determines that on-head detection 112 is “false.” With audioplethysmography 110, false detections can be mitigated without adding additional sensors (e.g., another infrared sensor, another proximity sensor, or a motion sensor) and without utilizing more complex and costly optical sensors. In addition to or instead of on-head detection 112, the hearable 102 can perform hearable-adjustment detection 114, as further described with respect to FIG. 2-2.

FIG. 2-2 illustrates example environments 212-1 and 212-2 for performing hearable-adjustment detection 114 using active acoustic sensing. While using and/or wearing a hearable 102, the user 106 may adjust a position of the hearable 102 relative to their ear 108. In the environment 212-1, the user 106 changes an orientation of the hearable 102 by rotating and/or twisting the hearable 102 clockwise or counter-clockwise, as indicated at 214. In the environment 212-2, the user 106 changes an insertion depth of the hearable 102 by pushing it farther into the ear 108 or pulling it farther out of the ear 108. Generally speaking, adjusting or re-adjusting a position of the hearable 102 can refer to changing an orientation of the hearable 102, rotating the hearable 102, changing an insertion depth of the hearable 102, changing a distance between the hearable 102 and the ear canal 116, and/or repositioning the hearable 102 at the ear 108.

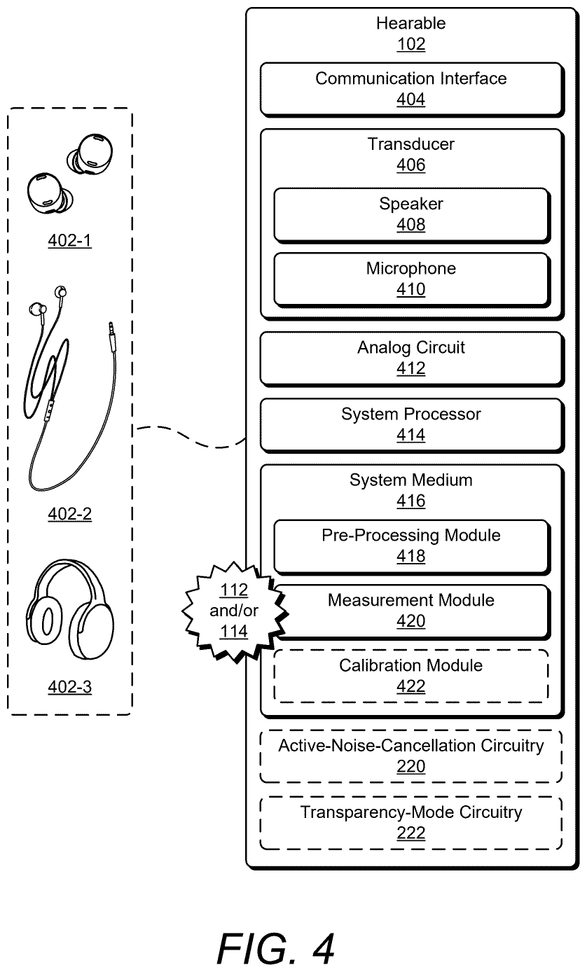

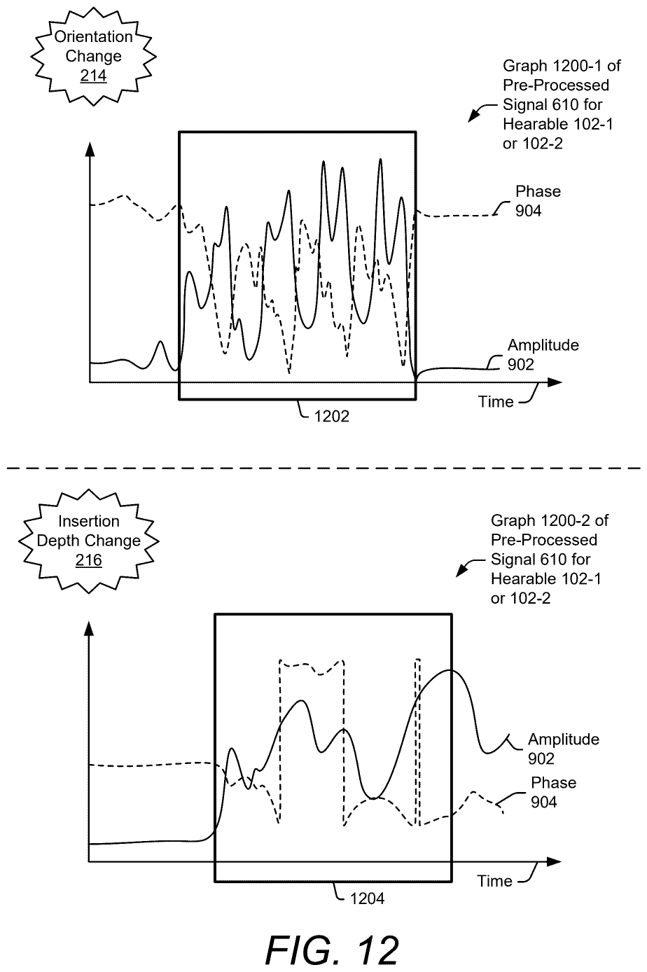

In general, the repositioning of the hearable 102 changes a position of a transducer of the hearable 102 (e.g., the transducer 406 of FIG. 4) relative to the ear canal 116. As such, acoustic signals that propagate through the ear canal 116 can travel along different paths relative to a previous position of the hearable 102. With audioplethysmography 110, the hearable 102 can detect changes to the characteristics of the acoustic receive signal 504, as further described with respect to FIG. 12. In general, an intentional re-adjusting of the hearable 102 by the user 106 can have a significantly greater impact on the acoustic receive signal compared to other body motions or activities (e.g., talking, walking, running, or jumping), which may inadvertently change a position of the hearable 102. Sometimes the signal fluctuations caused by the intentional repositioning of the hearable 102 by the user 106 can be on the order of thirty times greater than the fluctuations indirectly caused by other activities. This enables audioplethysmography 110 to readily distinguish between the user 106 adjusting the hearable 102 and the user 106 performing some other activity.

Adjusting a position of the hearable 102 while it is operating and being worn can present several challenges. A first challenge involves a touch-based control 218 of the hearable 102 (e.g., a control function of the hearable 102 based on a user 106's touch and thus in particular the possibility to control at least one function of the hearable 102 and/or the computing device 104 by the user 106 touching a portion of the hearable 102). Due to the hearable 102's compact design, it can be challenging for the user 106 to avoid activating the touch-based control 218 while adjusting the position of the hearable 102. The unintentional activation of these controls can become an annoyance and degrade the user experience. A second challenge involves active-noise-cancellation (ANC) circuitry 220 (ANC circuitry 220) and/or transparency-mode (TM) circuitry 222 (TM circuitry 222) of the hearable 102. Both the active-noise cancellation circuitry 220 and the transparency-mode circuitry 222 can have a feedback loop that can unintentionally produce a “howling” sound when the user 106 adjusts the hearable 102. Left unchecked, this howling sound can become annoying and degrade the user experience.

To address these challenges, the hearable 102 can use hearable-adjustment detection 114 to improve the user experience. More specifically, the hearable 102 can automatically adjust operations of the touch-based control 218, the active-noise-cancellation circuitry 220, and/or the transparency-mode circuitry 222 based on hearable-adjustment detection 114.

Consider an example in which the touch-based control 218 can be in an active state 224 or an inactive state 226. In the active state 224, the user 106 can use the touch-based control 218 to interact with the hearable 102 (e.g., to control an operation of the hearable 102). In the inactive state 224, the touch-based control 218 is temporarily disabled and prevents the user 106 from interacting with the hearable 102 via the touch-based control 218.

Upon detecting the user 106 adjusting the hearable 102, the hearable 102 can disable the touch-based control 218 to prevent accidental activation while the user 106 continues adjusting the hearable 102. For instance, if the hearable-adjustment detection 114 determines that the user 106 is adjusting the position of the hearable 102, the hearable 102 causes the touch-based control 218 to transition from the active state 224 to the inactive state 226. Alternatively, if the hearable-adjustment detection 114 determines that the user 106 is not adjusting the position of the hearable 102, the hearable 102 causes the touch-based control 218 to be in the active state 224.

The transitioning of the touch-based control 218 from the inactive state 226 to the active state 224 can alternatively be controlled by a timer or a delay circuit. For example, the touch-based control 218 can transition from the inactive state 226 to the active state 224 based on an expiration of a timer that was initiated based on the touch-based control 218 transitioning from the active state 224 to the inactive state 226. A duration of time during which the touch-based control 218 is in the inactive state 226 can be predetermined and/or set by the user 106 via the computing device 104.

In another example, the active-noise-cancellation circuitry 220 and/or the transparency-mode circuitry 222 can each selectively operate in a normal mode 228 or a light mode 230. The normal mode 228 is associated with a first amount of feedback gain. In contrast, the light mode 228 is associated with a second amount of feedback gain that is less than the first amount of feedback gain. In general, reducing the feedback gain reduces a probability that howling occurs.

Upon detecting the user 106 adjusting the hearable 102, the hearable 102 can take other actions to improve the user experience in addition to or instead of the actions described above. For example, the hearable 102 can activate the light mode 230 associated with active noise cancellation and/or a transparency mode. More specifically, if the hearable-adjustment detection 114 determines that the user 106 is adjusting a position of the hearable 102, the hearable 102 causes the active-noise-cancellation circuitry 220 and/or the transparency-mode circuitry 222 to transition from the normal mode 228 to the light mode 230. Alternatively, if the hearable-adjustment detection 114 determines that the user 106 is not adjusting the position of the hearable 102, the hearable 102 causes the active-noise-cancellation circuitry 220 and/or the transparency-mode circuitry 222 to operate in accordance with the normal mode 228. The transitioning of the active-noise-cancellation circuitry 220 and/or the transparency-mode circuitry 222 from the light mode 230 to the normal mode 228 can be alternatively be controlled based on a timer or a delay circuit, similar to the touch-based control 218.

By dynamically changing between the normal mode 228 or the light mode 230 depending on whether the user 106 is repositioning the hearable 102, the hearable 102 can mitigate howling and thereby improve the user experience. In some cases, the hearable 102 can cause the computing device 104 to indicate a current state or mode of the touch-based control 218, the active-noise-cancellation circuitry 220, and/or the transparency-mode circuitry 222. In this manner, hearable-adjustment detection 114 can optionally be used to control an operation of the computing device 104.

The hearable 102 can utilize the hearable-adjustment detection 114 to control other processes or operations that are performed by the hearable 102. Consider an example process that can be negatively impacted by the user 106 adjusting the hearable 102. In this case, the hearable-adjustment detection 114 can temporarily disable this process if the user 106 is determined to be adjusting the position of the hearable 102. An example process can include a speech process, such as voice activity detection, voice authentication, speech recognition, conversation detection, and/or a voice assistant service. The speech process can be negatively impacted if the user 106 accidentally covers a microphone of the hearable 102 while adjusting the position of the hearable 102. As such, hearable-adjustment detection 114 can cause the speech process to be temporarily disabled while the adjusting occurs and can cause the speech process to resume once the user 106 stops adjusting the hearable 102.

Audioplethysmography 110 enables the hearable 102 to achieve a lower false alarm rate for hearable-adjustment detection 114 compared to another hearable 102 that relies on another type of sensor, such as an inertial measurement unit, to perform hearable-adjustment detection. This other hearable can use the inertial measurement unit to detect the user repositioning the hearable. The inertial measurement unit, however, can be sensitive to other movements that are made by the user 106. It can therefore be challenging for the inertial measurement unit to distinguish between the user 106 adjusting the hearable and the user 106 performing other activities, such as talking, walking, or running, which can inadvertently reposition the hearable. Relying on the inertial measurement unit for hearable-adjustment detection 114 can cause the hearable to have a significantly high false alarm rate, which can negatively impact the user experience.

To address this issue, techniques for performing hearable-adjustment detection 114 using audioplethysmography 110 are described. Audioplethysmography 110 is less susceptible to noise compared to the inertial measurement unit because a wavelength of an acoustic signal that is received using audioplethysmography 110 can be on-par with a distance the hearable 102 moves due to the repositioning. This causes characteristics of the acoustic signal to be modified by a significant amount (e.g., meeting or exceeding a threshold) compared to other motions that are much larger relative to the wavelength of the acoustic signal. By using audioplethysmography 110 for hearable-adjustment detection 114, the hearable 102 can support hearable-adjustment detection 114 while the user 106 performs various activities, including talking, walking, and/or running. The computing device 104 and the hearable 102 are further described with respect to FIGS. 3 and 4, respectively.

FIG. 3 illustrates an example implementation of the computing device 104. The computing device 104 is illustrated with various non-limiting example devices including a desktop computer 104-1, a tablet 104-2, a laptop 104-3, a television 104-4, a computing watch 104-5, computing glasses 104-6, a gaming system 104-7, a microwave 104-8, and a vehicle 104-9. Other devices may also be used, such as an augmented and/or virtual reality headset, a home service device, a smart speaker, a smart thermostat, a baby monitor, a Wi-Fi™ router, a drone, a trackpad, a drawing pad, a netbook, an e-reader, a home automation and control system, a wall display, and another home appliance. Note that the computing device 104 can be wearable, non-wearable but mobile, or relatively immobile (e.g., desktops and appliances).

The computing device 104 includes one or more computer processors 302 and at least one computer-readable medium 304, which includes memory media and storage media. Applications and/or an operating system (not shown) embodied as computer-readable instructions on the computer-readable medium 304 can be executed by the computer processor 302 to provide some of the functionalities described herein. The computer-readable medium 304 can optionally include an application 306, which can utilize some aspect of on-head detection 112 and/or hearable-adjustment detection 114. Generally speaking, the application 306 can use information provided by the hearable 102 to perform an action. An example action can include changing the audio output state 206 of the computing device 104, as described with respect to FIG. 2-1. Another example action can include playing or pausing the rendering of the audio content 208. In yet another example, the computing device 104 can display a status indicator that can indicate a state of the touch-based control 218, a mode of the active-noise-cancellation circuitry 220, and/or a mode of the transparency-mode circuitry 222.

The computing device 104 can also include a network interface 308 for communicating data over wired, wireless, or optical networks. For example, the network interface 308 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. The computing device 104 may also include the display 310. Although not explicitly shown, the hearable 102 can be integrated within the computing device 104, or can connect physically or wirelessly to the computing device 104. The hearable 102 is further described with respect to FIG. 4.

FIG. 4 illustrates an example hearable 102. The hearable 102 is illustrated with various non-limiting example devices, including wireless earbuds 402-1, wired earbuds 402-2, and headphones 402-3. Other example hearables 102 can also include hearing aids. The earbuds 402-1 and 402-2 are a type of in-ear device that fits into the ear canal 116. Each earbud 402-1 or 402-2 can represent a hearable 102. Headphones 402-3 can rest on top of or over the ears 108. The headphones 402-3 can represent closed-back headphones, open-back headphones, on-ear headphones, or over-ear headphones. Each headphone 402-2 includes two hearables 102, which are physically packaged together. The headphones 402-3 may be designed in some manner or may utilize techniques, such as beamforming, to assist with directing signals used for audioplethysmography 110 into the ear canal 116. In general, there is one hearable 102 for each ear 108.

The hearable 102 includes a communication interface 404 to communicate with the computing device 104, though this need not be used when the hearable 102 is integrated within the computing device 104. The communication interface 404 can be a wired interface or a wireless interface, in which audio content is passed from the computing device 104 to the hearable 102. The hearable 102 can also use the communication interface 404 to pass data associated with audioplethysmography 110, on-head detection 112, and/or hearable-adjustment detection 114 to the computing device 104. In general, the data provided by the communication interface 404 is in a format usable by the application 306 or the computing device 104.

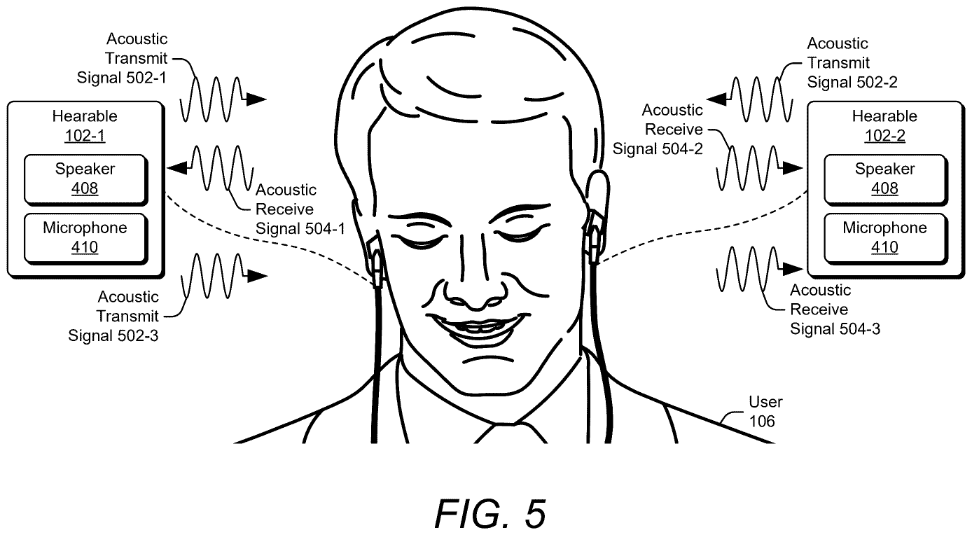

The communication interface 404 also enables the hearable 102 to communicate with another hearable 102. During bistatic sensing, for instance, the hearable 102 can use the communication interface 404 to coordinate with the other hearable 102 to support two-ear audioplethysmography 110, as further described with respect to FIG. 5. In particular, the transmitting hearable 102 can communicate timing and waveform information to the receiving hearable 102 to enable the receiving hearable 102 to appropriately demodulate a received acoustic signal.

The hearable 102 includes at least one transducer 406 that can convert electrical signals into sound waves. The transducer 406 can also detect and convert sound waves into electrical signals. These sound waves may include ultrasonic frequencies, which may be used for audioplethysmography 110. In particular, a frequency spectrum (e.g., range of frequencies) that the transducer 406 uses to generate an acoustic signal can include frequencies from a low-end of the audible range to a high-end of the ultrasonic range, e.g., between 20 hertz (Hz) to 2 megahertz (MHz). Other example frequency spectrums for audioplethysmography 110 can encompass frequencies between 20 Hz and 20 kilohertz (kHz), between 20 kHz and 2 MHz, between 20 and 60 kHz, or between 30 and 40 kHz.

In an example implementation, the transducer 406 has a monostatic topology. With this topology, the transducer 406 can convert the electrical signals into sound waves and convert sound waves into electrical signals (e.g., can transmit or receive acoustic signals). Example monostatic transducers may include piezoelectric transducers, capacitive transducers, and micro-machined ultrasonic transducers (MUTs) that use microelectromechanical systems (MEMS) technology.

Alternatively, the transducer 406 can be implemented with a bistatic topology, which includes multiple transducers that are physically separate. In this case, a first transducer converts the electrical signal into sound waves (e.g., transmits acoustic signals), and a second transducer converts sound waves into an electrical signal (e.g., receives the acoustic signals). An example bistatic topology can be implemented using at least one speaker 408 and at least one microphone 410. The speaker 408 and the microphone 410 can be dedicated for audioplethysmography 110 or can be used for both audioplethysmography 110 and other functions of the computing device 104 (e.g., passive audio sensing, presenting audible content to the user 106, capturing the user 106's voice for a phone call, or for voice control).

In general, the speaker 408 and the microphone 410 are directed towards the ear canal 116 (e.g., oriented towards the ear canal 116). Accordingly, the speaker 408 can direct acoustic signals towards the ear canal 116, and the microphone 410 is responsive to receiving acoustic signals from the direction associated with the ear canal 116.

The hearable 102 includes at least one analog circuit 412, which includes circuitry and logic for conditioning electrical signals in an analog domain. The analog circuit 412 can include analog-to-digital converters, digital-to-analog converters, amplifiers, filters, mixers, and switches for generating and modifying electrical signals. In some implementations, the analog circuit 412 includes other hardware circuitry associated with the speaker 408 or microphone 410.

The hearable 102 also includes at least one system processor 414 and at least one system medium 416 (e.g., one or more computer-readable storage media). In the depicted configuration, the system medium 416 includes a pre-processing module 418 and a measurement module 420. The system medium 416 also optionally includes a calibration module 422. The pre-processing module 418, the measurement module 420, and the calibration module 422 can be implemented using hardware, software, firmware, or a combination thereof. In this example, the system processor 414 implements the pre-processing module 418, the measurement module 420, and the calibration module 422. In an alternative example, the computer processor 302 of the computing device 104 can implement at least a portion of the pre-processing module 418, the measurement module 420, and/or the calibration module 422. In this case, the hearable 102 can communicate digital samples of the acoustic signals to the computing device 104 using the communication interface 404.

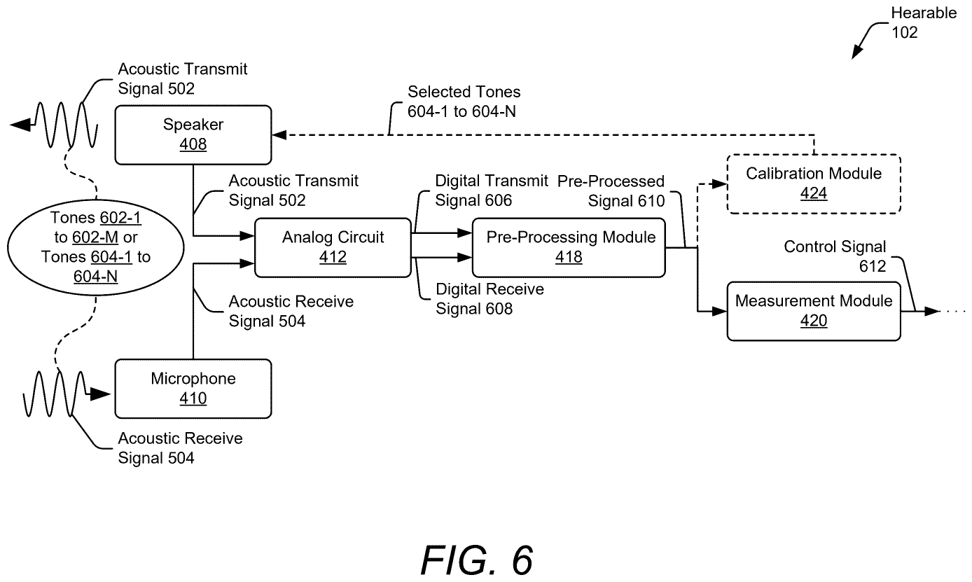

Operations of the pre-processing module 418, the measurement module 420, and the calibration module 422 are further described with respect to FIG. 6. Aspects of on-head detection 112 and/or hearable-adjustment detection 114 can be performed, at least partially, by the measurement module 420.

Some hearables 102 include the active-noise-cancellation circuitry 220, which enables the hearable 102 to reduce background or environmental noise. In this case, the microphone 410 used for audioplethysmography 110 can be implemented using a feedback microphone of the active-noise-cancellation circuit 424. During active noise cancellation, the feedback microphone provides feedback information regarding the performance of the active noise cancellation. During audioplethysmography 110, the feedback microphone receives an acoustic signal, which is provided to the pre-processing module 418. In some situations, active noise cancellation and audioplethysmography 110 are performed simultaneously using the feedback microphone. In this case, the acoustic signal received by the feedback microphone can be provided to the pre-processing module 418 and the feedback signal for active noise cancellation can be provided to the active-noise-cancellation circuit 424.

The hearable 102 can optionally include the transparency-mode circuitry 222. The transparency-mode circuitry 222 enables the hearable 102 to pass (and optionally amplify) the background or environmental noise to the user 106.

Although not explicitly shown in FIG. 4, the system medium 416 can also include the application 306 (or another application). In this case, the hearable 102 uses the application 306 to perform one or more aspects of on-head detection 112 and/or hearable-adjustment detection 114. Different types of audioplethysmography 110 are further described with respect to FIG. 5.

### Active Acoustic Sensing

FIG. 5 illustrates example operations of two hearables 102-1 and 102-2. In a first example operation, the hearables 102-1 and 102-2 perform single-ear audioplethysmography 110. This means that the hearables 102-1 and 102-2 independently perform audioplethysmography 110 on different ears 108 of the user 106. In this case, the first hearable 102-1 is proximate to (arranged at) the user 106's right ear 108, and the second hearable 102-2 is proximate to (arranged at) the user 106's left ear 108. Each hearable 102-1 and 102-2 includes a speaker 408 and a microphone 410. The hearables 102-1 and 102-2 can operate in a monostatic manner during the same time period or during different time periods. In other words, each hearable 102-1 and 102-2 can independently transmit and receive acoustic signals.

For example, the first hearable 102-1 uses the speaker 408 to transmit a first acoustic transmit 502-1, which propagates within at least a portion of the user 106's right ear canal 116. The first hearable 102-1 uses the microphone 410 to receive a first acoustic receive signal 504-1. The first acoustic receive signal 504-1 represents a version of the first acoustic transmit signal 502-1 that is modified, at least in part, by the acoustic circuit associated with the right ear canal 116. This modification can change an amplitude, phase, and/or frequency of the first acoustic receive signal 504-1 relative to the first acoustic transmit signal 502-1.

Similarly, the second hearable 102-2 uses the speaker 408 to transmit a second acoustic transmit signal 502-2, which propagates within at least a portion of the user 106's left ear canal 116. The second hearable 102-2 uses the microphone 410 to receive a second acoustic receive signal 504-2. The second acoustic receive signal 504-2 represents a version of the second acoustic transmit signal 502-2 that is modified by the acoustic circuit associated with the left ear canal 116. This modification can change an amplitude, phase, and/or frequency of the second acoustic receive signal 504-2 relative to the second acoustic transmit signal 502-2.

The techniques of single-ear audioplethysmography 110 can be particularly beneficial as it enables the computing device 104 to compile information from both hearables 102-1 and 102-2, which can further improve measurement confidence. For some aspects of audioplethysmography 110, it can be beneficial to analyze the acoustic channel between two ears 108, as further described below.

In a second example operation, the two hearables 102-1 and 102-2 perform two-ear audioplethysmography 110. This means that the hearables 102-1 and 102-2 jointly perform audioplethysmography 110 across two ears 108 of the user 106. In this case, at least one of the hearables 102 (e.g., the first hearable 102-1) includes the speaker 408, and at least one of the other hearables 102 (e.g., the second hearable 102-2) includes the microphone 410. The hearables 102-1 and 102-2 operate together in a bistatic manner during the same time period.

During operation, the first hearable 102-1 transmits a third acoustic transmit 502-3 using the speaker 408. The third acoustic transmit signal 502-3 propagates through the user 106's right ear canal 116. The third acoustic transmit signal 502-3 also propagates through an acoustic channel that exists between the right and left ears 108. In the left ear 108, the third acoustic transmit signal 502-3 propagates through the user 106's left ear canal 116 and is represented as a third acoustic receive signal 504-3. The second hearable 102-2 receives the third acoustic receive signal 504-3 using the microphone 410. The third acoustic receive signal 504-3 represents a version of the third acoustic transmit signal 502-3 that is modified by the acoustic circuit associated with the right ear canal 116, modified by the acoustic channel associated with the user 106's face, and modified by the acoustic circuit associated with the left ear canal 116. This modification can change an amplitude, phase, and/or frequency of the third acoustic receive signal 504-3 relative to the third acoustic transmit signal 502-3. In some cases, the hearable 102-2 measures the time-of-flight (ToF) associated with the propagation from the first hearable 102-1 to the second hearable 102-2. Sometimes a combination of single-ear and two-ear audioplethysmography 110 are applied to further improve measurement confidence.

The acoustic transmit signals 502 of FIG. 5 can represent a variety of different types of signals as described above with respect to FIG. 4. In example implementations, the acoustic transmit signal 502 can be a continuous-wave signal (e.g., a sinusoidal signal) or a pulsed signal. Some acoustic transmit signals 502 can have a particular tone (or frequency). Other acoustic transmit signals 502 can have multiple tones (or multiple frequencies). A variety of modulations can be applied to generate the acoustic transmit signal 502. Example modulations include linear frequency modulations, triangular frequency modulations, stepped frequency modulations, phase modulations, or amplitude modulations. The acoustic transmit signal 502 can be transmitted as part of a calibration procedure or a measurement procedure, as further described as part of FIG. 6.

FIG. 6 illustrates an example implementation of the hearable 102. In the depicted configuration, the hearable 102 includes the speaker 408, the microphone 410, the analog circuit 412, the pre-processing module 418, the measurement module 420, and the calibration module 422. Other implementations of the hearable 102 are also possible in which the hearable 102 does not include the calibration module 422 to reduce processing power requirements. In this case, the pre-processing module 418 can perform aspects of frequency selection as further described below to improve the signal-to-noise ratio for audioplethysmography 110.

Outputs of the speaker 408 and the microphone 410 are coupled to inputs of the analog circuit 412. The pre-processing module 418 has inputs that are coupled to outputs of the analog circuit 412. The pre-processing module 418 also has an output that is coupled to inputs of the measurement module 420 and the calibration module 422. In an example implementation, the pre-processing module 418 includes at least one in-phase and quadrature mixer (I/Q mixer) and at least one filter. The in-phase and quadrature mixer performs frequency down-conversion and can be implemented using at least two mixers, at least one phase shifter, and at least one combiner (e.g., a summation circuit). The filter attenuates intermodulation products that are generated by the in-phase and quadrature mixer. In an example implementation, the filter is implemented using a low-pass filter.

The pre-processing module 418 can optionally include at least one frequency selector. The frequency selector can identify and select one or more tones (or carrier frequencies) that provide a high-quality signal for later processing. The frequency selector can further pass the selected tones to other processing modules (e.g., the measurement module 420) and filter (or attenuate) other tones that are not selected. The frequency selector can be implemented in a similar manner as the calibration module 422, which is further described below.

An output of the measurement module 420 can be passed to the computing device 104, the application 306, or another process that is performed by the hearable 102. The measurement module 420 can be implemented using a variety of techniques, including signal processing algorithms and/or a machine-learned model. With the measurement module 420, the hearable 102 performs a measurement procedure that includes performing on-head detection 112 and/or hearable-adjustment detection 114 using audioplethysmography 110.

The calibration module 422 has an output that is coupled to the speaker 408. The calibration module 422 includes at least one frequency selector. The frequency selector can include at least one amplitude detector, at least one phase detector, at least one quality detector, and at least one comparator. Using the frequency selector, the calibration module 422 can perform a calibration procedure that determines appropriate characteristics (e.g., waveform or signal characteristics) of acoustic transmit signals 502 to improve audioplethysmography 110 (e.g., to enhance the performance of on-head detection 112 and/or hearable-adjustment detection 114). The calibration procedure enables audioplethysmography 110 to take into account the wear of the hearable 102 (e.g., the position of the hearable 102 relative to the ear canal 116) and the physical structure of the ear canal 116 to determine a transmission frequency that can increase sensitivity.

Consider an example operation of the hearable 102 in accordance with single-ear audioplethysmography 110. In this example, the hearable 102 includes the calibration module 422. With the calibration module 422, the hearable 102 can perform a calibration procedure prior to performing a measurement procedure. In some circumstances, the hearable 102 can perform on-head detection 112 and initiate the calibration procedure and/or the measurement procedure based on a determination that on-head detection 112 is “true.” In other circumstances, the hearable 102 can initiate the calibration procedure based on a specified schedule or a timer, which can be controlled by the user 106 via the computing device 104 or can be controlled by the hearable 102. The calibration procedure and the measurement procedure are further described below.

During both the calibration procedure and the measurement procedure, the speaker 408 transmits the acoustic transmit signal 502 and the microphone 410 receives the acoustic receive signal 504. During the calibration procedure, the acoustic transmit signal 502 and the acoustic receive signal 504 can have tones 602-1 to 602-M, where M represents a positive integer. The multiple tones 602-1 to 602-M can be transmitted in parallel or in series over a given time interval. In this case, the acoustic transmit signal 502 can have a particular bandwidth on the order of several kilohertz. For example, the acoustic transmit signal 502 can have a bandwidth of approximately 4, 5, 6, 8, 10, 16, or 20 kHz. In example implementations, the acoustic transmit signal 502 is transmitted over multiple seconds, such as 2, 3, 4, 6, or more seconds. A duration of each tone 602 can be evenly divided over a total duration of the acoustic transmit signal 502.

In an example implementation, the acoustic transmit signal 502 for the calibration procedure can have seven tones 602 (e.g., M equals 7). In some cases, the tones 602 are evenly distributed across an interval. For example, the tones 602 can be in 1 kHz increments between 32 kHz and 38 kHz (e.g., at approximately 32, 33, 34, 35, 36, 37, and 38 kHz). The term “approximately” means that the tones 602 can be within 5% of a given value or less (e.g., within 3%, 2%, or 1% of the given value).

An amplitude of the calibration procedure's acoustic transmit signal 502 can be approximately the same across the tones 602-1 to 602-M. In this manner, power is evenly distributed across each tone 602. The quantity of tones 602 (e.g., M) can be determined based on an output power of the speaker 408. Increasing the quantity of tones 602 can increase a likelihood that the hearable 102 can support on-head detection 112 and/or hearable-adjustment detection 114 across various conditions including user wear and a physical structure of the user 106's ear canal 116. However, an amplitude of the acoustic transmit signal 502 can be limited across these tones 602 based on the output power of the speaker 408. Thus, the quantity of tones 602 can be optimized based on an amount of output power that is available for audioplethysmography 110.

During the measurement procedure, the acoustic transmit signal 502 and the acoustic receive signal 504 can have selected tones 604-1 to 604-N, where N represents a positive integer that is less than or equal to M. The selected tones 604-1 to 604-N can represent a subset (sometimes a proper subset) of the tones 602-1 to 602-M. The selected tones 604 can be transmitted in parallel or in series over a given time interval.

An amplitude of the measurement procedure's acoustic transmit signal 502 can be approximately the same across the selected tones 604-1 to 604-N. In this manner, power is evenly distributed across each selected tone. The amplitude of the measurement procedure's acoustic transmit signal 502 can be higher than the amplitude of the calibration procedure's acoustic transmit signal 502 because the available output power is distributed across fewer tones. Additionally or alternatively, a duration of each of the selected tones 604 of the measurement procedure's acoustic transmit signal 502 can be longer than the duration of the tones 602 of the calibration procedure's acoustic transmit signal 502. The higher amplitude and/or the longer duration can further improve the signal-to-noise ratio performance of the hearable 102 for audioplethysmography 110. By using a few selected tones 604 that were determined to improve signal-to-noise ratio performance, the measurement procedure can achieve a higher level of accuracy and sensitivity for on-head detection 112 and/or hearable-adjustment detection 114.

The analog circuit 412 performs analog-to-digital conversion to generate a digital transmit signal 606 and a digital receive signal 608 based on the acoustic transmit signal 502 and the acoustic receive signal 504, respectively. The pre-processing module 418 performs frequency downconversion and demodulation to generate at least one pre-processed signal 610 based on the digital transmit signal 606 and the digital receive signal 608. The pre-processing module 418 can also apply filtering to generate the pre-processed signal 610.

Optionally, as part of the calibration procedure, the calibration module 422 processes the pre-processed signal 610 to determine the selected tones 604-1 to 604-N. The selected tones 604-1 to 604-N can improve performance of audioplethysmography 110 during the measurement procedure. To determine the selected tones 604-1 to 604-N, the calibration module 422 extracts the amplitude and/or phase of the pre-processed signal 610 using the amplitude detector and the phase detector, respectively. The quality detector of the calibration module 422 measures quality metrics for each tone (or frequency) of the pre-processed signal 610 and for each of the characteristics (e.g., amplitude and/or phase). Example quality metrics can include peak-to-average ratios and/or signal-to-noise ratios. The peak-to-average ratio represents a peak intensity within a frequency range of interest divided by an average intensity within this frequency range. A higher quality metric indicates a higher-quality signal, or more generally, better performance for audioplethysmography 110.

The comparator of the calibration module 422 can evaluate the quality metrics with respect to a threshold. In an example implementation, the comparator determines the selected tones 604-1 to 604-N for a subsequent measurement procedure based on the frequencies associated with the quality metrics that are greater than or equal to a threshold. Additionally or alternatively, the comparator can evaluate the quality metrics with respect to each other. In an example implementation, the comparator determines one of the selected tones based on a frequency with the highest quality metric across the amplitude. Also, the comparator can determine one of the selected tones 604-1 to 604-N based on a frequency with the highest quality metric across the phase. In other implementations, the comparator can determine a single selected tone based on a frequency having the highest quality metric associated with either the amplitude or the phase.

In general, the calibration module 422 enables the selected tones 604-1 to 604-N to be dynamically adjusted prior to the measurement procedure based on a current environment, which can account for a wear of the hearable 102 (e.g., a current insertion depth and/or rotation), a physical structure of the user 106's ear canal 116, and a response characteristic of the hearable 102 (e.g., speaker, microphone, and/or housing). In this manner, the calibration module 422 can improve the signal-to-noise ratio performance of the hearable 102 for the measurement procedure. The calibration module 422 can also determine which tones 604 generate acoustic receive signals 504 with desired characteristics for on-head detection 112 and/or hearable-adjustment detection 114. In general, the calibration procedure can be performed while the user 106 is wearing the hearable 102.

The calibration module 422 communicates the selected tones 604-1 to 604-N to the speaker 408 using a control signal. The speaker 408 accepts the control signal that identifies the selected tones 604-1 to 604-N and can transmit a subsequent acoustic transmit signal 502 for on-head detection 112 and/or hearable-adjustment detection 114 using the selected tones 604-1 to 604-N. With the calibration procedure, the hearable 102 can dynamically adjust the transmission frequency (e.g., one or more carrier frequencies) each time the seal 118 is formed (e.g., based on the wear of the hearable 102) and based on the unique physical structure of the ear 108. Through this calibration procedure, the hearables 102 on different ears 108 may operate with one or more different acoustic frequencies (e.g., ultrasound frequencies).

As part of the measurement procedure, the measurement module 420 can perform aspects of on-head detection 112 and/or hearable-adjustment detection 114 using the pre-processed signal 610 to generate a control signal 612. In an example implementation, the control signal 612 has a first state that indicates on-head detection 112 is true and has a second state that indicates on-head detection is false. In another example implementation, the control signal 612 has a first state that indicates the user 106 is adjusting a position of the hearable 102 and has a second state that indicates the user 106 is not adjusting the position of the hearable 102. In general, the control signal 612 can have multiple states and/or can pass different types of information associated with on-head detection 112 and/or hearable-adjustment detection 114.

To perform on-head detection 112 and/or hearable-adjustment detection 114, the measurement module 420 analyzes the pre-processed signal 610 and detects a significant variation in an amplitude and/or phase of the pre-processed signal 610. For on-head detection 112, this variation can be caused by the deformation in the ear canal 116 due to biometrics of the user 106. Additionally or alternatively, this varication can be caused by the user 106 adjusting the position of the hearable 102 for hearable-adjustment detection 114.

In general, the term “significantly” can mean that the values of the amplitude and/or the phase can change by 20% or more relative to a previous value (e.g., relative to an average of a set of previous values). Additionally or alternatively, a slope of the amplitude and/or the phase can vary significantly. Sometimes the slope of the amplitude and/or the phase can change signs (e.g., from a positive slope to a negative slope, or vice versa). A magnitude of the slope of the amplitude and/or the phase can sometimes change by approximately 10% or more.

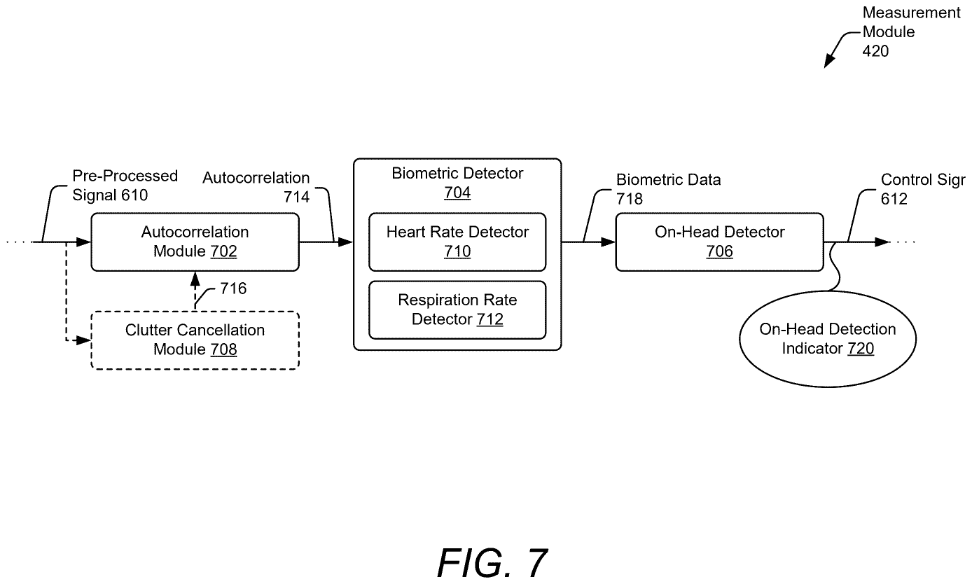

The measurement module 420 can be implemented in a variety of ways to detect the variation in the pre-processed signal 610. Various implementations can utilize signal processing techniques and/or a machine-learned model. In some example implementations, on-head detection 112 is used as an input or as a control gate for hearable-adjustment detection 114. If on-head detection 112 is false, for instance, hearable-adjustment detection 114 can also be determined to be false. An example implementation of the measurement module 420 for performing on-head detection 112 is further described with respect to FIG. 7.

Various techniques are described below for performing hearable-adjustment detection 114. A first technique analyzes a peak of the amplitude and/or phase of the acoustic receive signal 504. For example, the measurement module 420 determines that hearable-adjustment detection 114 is true based on a peak of the amplitude and/or phase exceeding a first predetermined threshold. A second technique analyzes a slope of the amplitude and/or phase of the acoustic receive signal 504. For example, the measurement module 420 determines that hearable-adjustment detection 114 is true based on a change in a slope of the amplitude and/or phase exceeding a second predetermined threshold. A third technique analyzes a variance of the amplitude and/or phase of the acoustic receive signal 504. For example, the measurement module 420 computes a variance of the pre-processed signal 610 and determines that hearable-adjustment detection 114 is true based on the variance exceeding a third predetermined threshold.

A fourth technique uses machine learning to perform hearable-adjustment detection 114 based on the acoustic receive signal 504. For example, the measurement module 420 includes a machine-learned model that is trained, using supervised learning, to detect a change in the pre-processed signal 610 that is associated with a situation in which hearable-adjustment detection 114 is true. The machine-learned model can be implemented using one or more neural networks. A neural network includes a group of connected nodes (e.g., neurons or perceptrons), which are organized into one or more layers. As an example, the machine-learned model includes a deep neural network, which includes an input layer, an output layer, and one or more hidden layers positioned between the input layer and the output layers. The nodes of the deep neural network can be partially-connected or fully-connected between the layers.

In some implementations, the neural network is a recurrent neural network (e.g., a long short-term memory (LSTM) neural network) with connections between nodes forming a cycle to retain information from a previous portion of an input data sequence for a subsequent portion of the input data sequence. In other cases, the neural network is a feed-forward neural network in which the connections between the nodes do not form a cycle. Additionally or alternatively, the machine-learned model includes another type of neural network, such as a convolutional neural network. The machine-learned model can also include one or more types of classification models, such as a binary classification model, a multi-class classification model, multi-label classification, and so forth.

In example implementations, the machine-learned model can be implemented using a single-channel-input machine-learned model or a multi-channel-input machine-learned model. The single-channel-input machine-learned model performs hearable-adjustment detection 114 based on the pre-processed signal 610 from one hearable 102. In contrast, the multi-channel-input machine-learned model performs hearable-adjustment detection 114 based on multiple pre-processed signals 610 provided by different hearables 102.

In general, the machine-learned model is trained using supervised learning to generate the control signal 612 based on at least a version of the acoustic receive signal 504. The supervised learning can use simulated (e.g., synthetic) data or measured (e.g., real) data for training purposes. The machine-learned model (or another machine-learned model) can also be trained to perform on-head detection 112 based on the pre-processed signal 610.

In FIG. 6, the calibration procedure and the measurement procedure are described as individual procedures that occur at different time intervals. In particular, the calibration procedure occurs before the measurement procedure. This enables the acoustic transmit signal 502 for the measurement procedure to be transmitted with fewer tones than the acoustic transmit signal 502 used for the calibration procedure, which can increase signal-to-noise ratio performance for audioplethysmography 110. In some implementations, however, the hearable 102 can have sufficient output power to perform the measurement procedure with the multiple tones 602-1 to 602-M using a single acoustic transmit signal 502. In this case, aspects of the calibration module 422 can be integrated within the pre-processing module 418 via a frequency selector. This frequency selector can effectively pass the selected tones 604-1 to 604-N to the measurement module 420.

### On-Head Detection

FIG. 7 illustrates an example implementation of the measurement module 420 for performing on-head detection 112 using active acoustic sensing. In the depicted configuration, the measurement module 420 includes at least one autocorrelation module 702, at least one biometric detector 704, and at least one on-head detector 706. The measurement module 420 can optionally include at least one clutter cancelation module 708. The autocorrelation module 702 processes digital samples of the acoustic receive signal 504 and outputs data in a format that is usable by the biometric detector 704. The biometric detector 704 determines (or measures) one or more biometrics (e.g., one or more physiological metrics) of the user 106 for on-head detection 112. In this example, the biometric detector 704 includes a heart rate detector 710 and/or a respiration rate detector 712. The heart rate detector 710 measures a heart rate of the user 106. The respiration rate detector 712 measures a respiration rate of the user 106. Additionally or alternatively, the biometric detector 704 can determine other biometrics, such as blood pressure, body temperature, or a carbon dioxide level. The clutter cancellation module 708 can attenuate undesired frequencies that are passed by the pre-processing module 418 to the measurement module 420.

During operation, the autocorrelation module 702 accepts the pre-processed signal 610 and applies an autocorrelation function to generate autocorrelation 714. The biometric detector 704 analyzes the autocorrelation 714 to measure a biometric of the user 106. For example, the heart rate detector 710 detects peaks of the autocorrelation 714 and measures the time interval between peaks. This time interval, or period of the autocorrelation 714, represents the user 106's heart rate. A similar process can occur for measuring the respiration rate using the respiration rate detector 712. In general, the biometric detector 704 measures a periodicity of the autocorrelation 714 to determine the user 106's heart rate and/or respiration rate.

Sometimes frequencies associated with other biometrics or noise can make it harder to accurately measure the desired biometric. To address this, the measurement module 420 can include and activate the clutter cancellation module 708. Instead of directly sending the pre-processed signal 610 to the autocorrelation module 702, the clutter cancellation module 708 operates on the pre-processed signal 610 and generates a modified pre-processed signal 716. For example, the clutter cancellation module 708 can attenuate slower frequencies associated with movement of the hearable 102. Additionally, if the biometric detector 704 includes the heart rate detector 710 and does not include the respiration rate detector 712, the clutter cancellation module 708 can attenuate frequencies associated with the user 106's respiration rate to make it easier to detect the user 106's heart rate. In a similar manner, if the biometric detector 704 includes the respiration rate detector 712 and does not include the heart rate detector 710, the clutter cancellation module 708 can attenuate frequencies associated with the user 106's heart rate to make it easier to detect the user 106's respiration rate. Alternatively, the heart rate detector 710 and/or the respiration rate detector 712 can apply an appropriate filter to detect the desired biometric.

In an example implementation, the clutter cancellation module 708 applies curve fitting (e.g., a fifth-order polynomial curve fit) onto the pre-processed signal 610 to generate a fitted curve. The fitted curve has a frequency that incorporates, at least in part, the frequency associated with noise or other physiological metrics that are not of interest. The clutter cancellation module 708 then subtracts the fitted curve from the pre-processed signal 610 to generate the modified pre-processed signal 716. The modified pre-processed signal 716 is passed to the autocorrelation module 702 and the measurement process continues.

The biometric detector 704 accepts the autocorrelation 714 and generates biometric data 718 based on the autocorrelation 714. If the hearable 102 is at the user 106's ear 108, the biometric data 718 can include one or more biometrics associated with the user 106, such as the user 106's heart rate and/or respiration rate. If the hearable 102 is not proximate to the user 106's ear 108, the biometric data 718 can indicate that no biometrics were observed or measured. For example, the biometric data 718 can include a null or some other indicator.

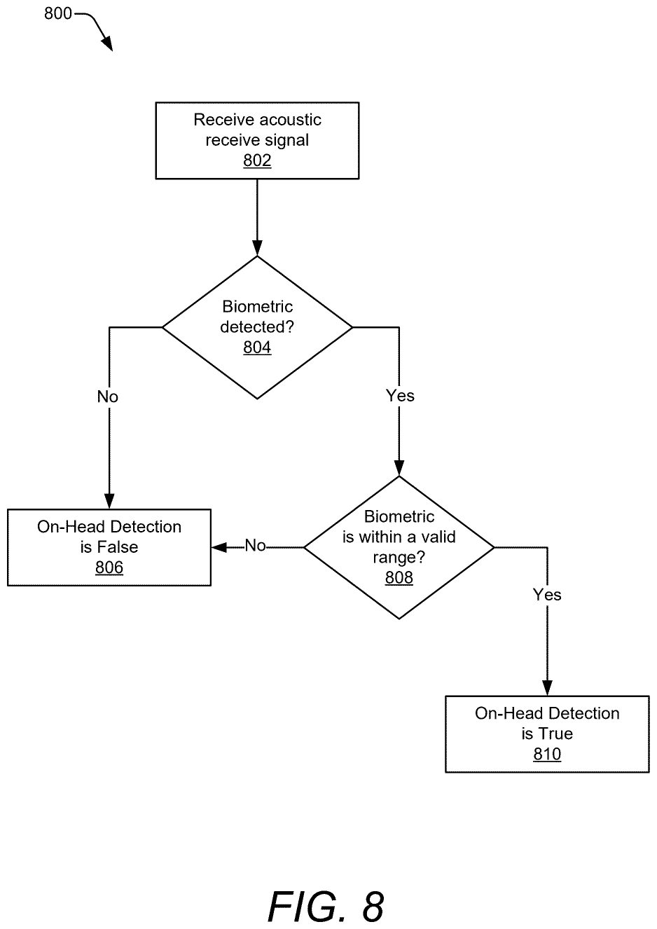

The on-head detector 706 accepts the biometric data 718 and generates the control signal 612 based on the biometric data 718. In this case, the control signal 612 includes an on-head detection indicator 720, which can be a Boolean value that indicates whether on-head detection 112 is “true” or “false.” In some cases, the on-head detector 706 can further evaluate a validity of the biometric data 718 for on-head detection 112, as further described with respect to FIG. 8.

FIG. 8 illustrates an example scheme 800 for performing aspects of on-head detection 112 using active acoustic sensing. At 802, the hearable receives the acoustic receive signal 504, as shown in FIG. 5. At 804, the measurement module 420 determines whether or not it detected a biometric of the user 106 based on the acoustic receive signal 504 (or a signal derived from the acoustic receive signal 504). If the measurement module 420 does not detect the biometric, the measurement module 420 determines that on-head detection 112 is false, as indicated at 806. In this case, the on-head detector 706 generates the on-head detection indicator 720 to indicate that on-head detection 112 is false. Otherwise, if the measurement module 420 detects (or measures) the biometric, the process continues at 808.

At 808, the on-head detector 706 determines whether the detected biometric is within a valid range. For example, the on-head detector 706 can evaluate whether the biometric data 718 is within a valid range of values (e.g., determine that the measured heart rate is within a range associated with a typical human's heart rate or determine that the measured respiration rate is within a range associated with a typical human's respiration rate). If the biometric is determined to be valid, the on-head detector 706 generates the on-head detection indicator 720 to indicate that on-head detection 112 is true, as indicated at 810. Otherwise, if the biometric is determined to be outside the valid range, the on-head detector 706 generates the on-head detection indicator 720 to indicate that on-head detection 112 is false, as indicated at 806.

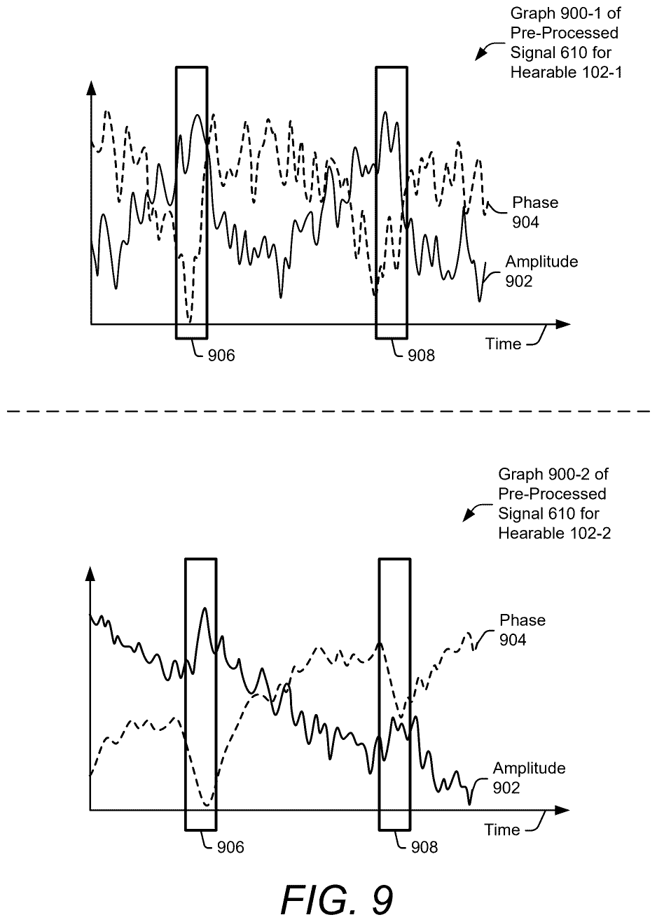

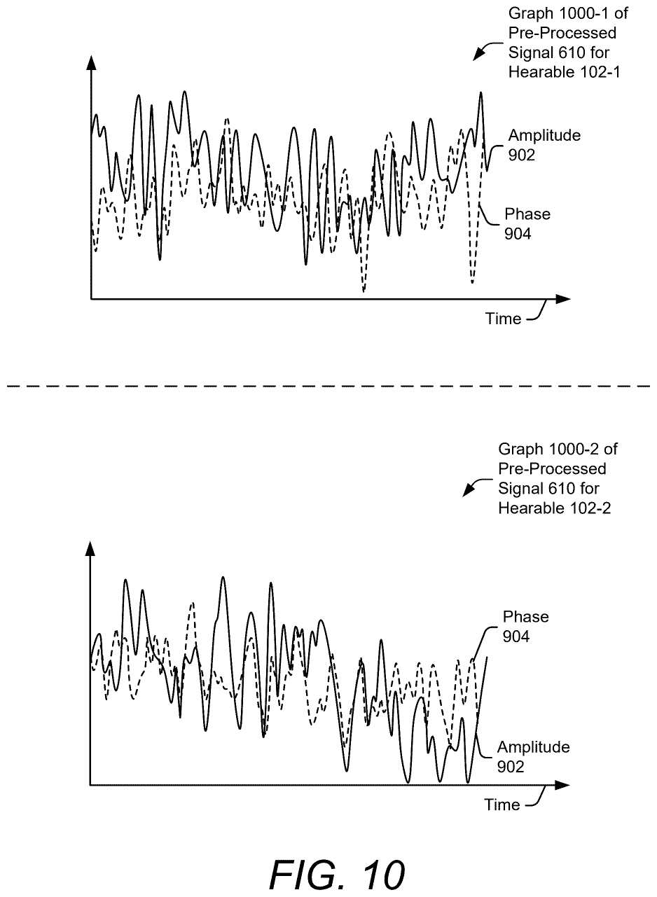

The hearable 102 can measure the biometric of the user 106 based on an amplitude of the acoustic receive signal 504, based on a phase of the acoustic receive signal 504, or based on both the amplitude and the phase of the acoustic receive signal 504, as further described with respect to FIGS. 9 and 10.

FIG. 9 illustrates an impact of the user 106 wearing the hearable 102. More specifically, FIG. 9 depicts example amplitudes and phases of pre-processed signals 610 generated by different hearables 102-1 and 102-2. As shown below, the pressure wave caused by one or more biometrics of the user 106 can significantly impact the amplitude and/or the phase of the pre-processed signals 610. In some instances, the change in the amplitude and/or the phase can be relative to a previous state or relative to a previous trend in the amplitude and/or the phase.

In some implementations, the measurement module 420 can perform on-head detection 112 based on the amplitude of the pre-processed signal 610 provided by the hearable 102-1, the phase of the pre-processed signal 610 provided by the hearable 102-1, the amplitude of the pre-processed signal 610 provided by the hearable 102-2, the phase of the pre-processed signal 610 provided by the hearable 102-2, or some combination thereof. Generally speaking, processing a larger quantity of signals and/or tones 604 provides more information to the measurement module 420. This can make it easier for the measurement module 420 to accurately perform on-head detection 112.

Graphs 900-1 and 900-2 in FIG. 9 depict amplitudes 902 and phases 904 of pre-processed signals 610 that are respectively generated by the hearables 102-1 and 102-2. Time is depicted along the horizontal axes of the graphs 900-1 and 900-2. During the time interval shown in the graphs 900-1 and 900-2, the user 106 wears the hearable 102. As such, the hearable 102 can use audioplethysmography 110 to measure one or more biometrics of the user 106 based on the acoustic receive signal 504. If the hearable 102 can measure one or more biometrics of the user 106, the hearable 102 can determine that on-head detection 112 is “true.” Consider an example in which the biometric detector 704 measures the user 106's heart rate.

During the time intervals indicated at 906 and 908, the user 106's heart beats. This causes the amplitude and/or phase of the pre-processed signals 610 to fluctuate. Further processing using the autocorrelation module 702 and optionally the clutter cancellation module 708 can further enable the biometric detector 704 to measure the heart rate based on the pre-processed signals 610 depicted in one or more of the graphs 900-1 and 900-2.

FIG. 10 illustrates an impact of the user 106 not wearing the hearable 102. Graphs 1000-1 and 1000-2 in FIG. 10 depict amplitudes 902 and phases 904 of pre-processed signals 610 that are respectively generated by the hearables 102-1 and 102-2. Time is depicted along the horizontal axes of the graphs 1000-1 and 1000-2. During the time interval depicted, the user 106 is not wearing the hearable 102. In some situations, the hearable 102 is placed on a flat surface, such as a table. In other situations, the user 106 holds the hearable 102 in their hand or puts the hearable 102 in a bag or pocket.

The hearable 102 uses audioplethysmography 110 to determine the absence of one or more biometrics within the pre-processed signals 610. Since the hearable 102 is unable to measure a biometric based on the pre-processed signals 610, the hearable 102 can determine that on-head detection 112 is “false.” A scale of the amplitudes 902 and the phases 704 may not necessarily be the same across the graphs 900-1, 900-2, 1000-1, and 1000-2. In general, the amplitude and/or phase of the audio receive signal 504 can be analyzed to measure a biometric of the user 106's while the user 106 is wearing the hearable 102. However, an impact of the user 106's biometrics on the amplitude and/or phase of the audio receive signal 504 is absent and not detected while the user 106 is not wearing the hearable 102. In general, the measurement module 420 can use various techniques, including those associated with signal/data processing and/or machine learning, for on-head detection 112.

Aspects of on-head detection 112 can be performed using one hearable 102 (e.g., the hearable 102-1 or 102-2) or multiple hearables 102 (e.g., the hearables 102-1 and 102-2). With multiple hearables 102 performing on-head detection 112, the hearable 102 can have higher confidence that at least one biometric of the user 106 can be detected if the hearable 102 is worn by the user 106. In general, the hearable 102 can perform on-head detection 112 by analyzing changes in the amplitude of the acoustic receive signal 504, changes in the phase of the acoustic receive signal 504, or changes in both the amplitude and phase of the acoustic receive signal 504.

### Hearable-Adjustment Detection

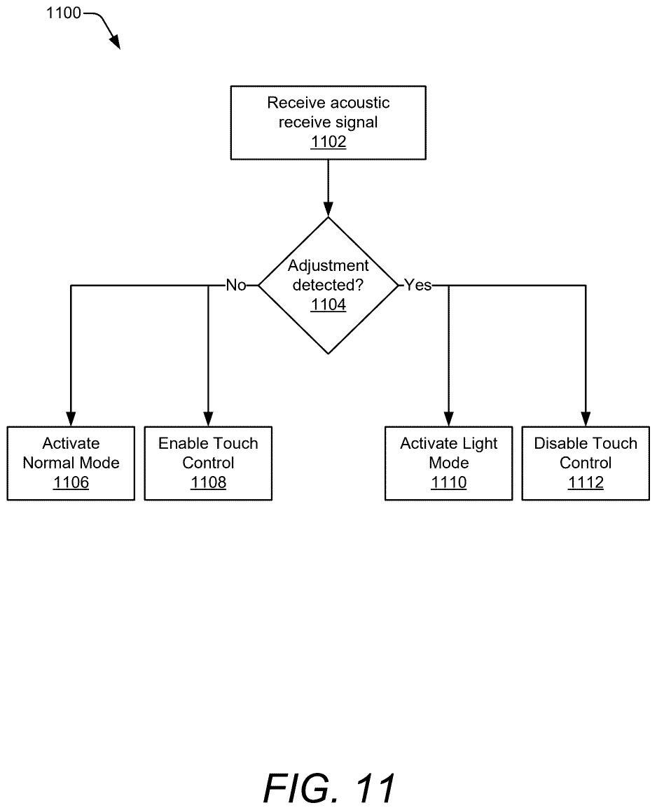

FIG. 11 illustrates an example scheme for performing aspects of hearable-adjustment detection 114 using active acoustic sensing. At 1102, the hearable 102 receives the acoustic receive signal 504, as shown in FIG. 5. At 1104, the hearable 102 determines whether or not it detected the user 106 adjusting a position of the hearable 102. If the hearable 102 determines that it is not being adjusted, operations can continue at 1106 and/or 1108. At 1106, the hearable 102 causes the active-noise-cancellation circuitry 220 and/or the transparency-mode circuitry 222 to operate in accordance with the normal mode 228. The normal mode 228 enables a first amount of feedback gain (e.g., a first gain) to be applied for active noise cancellation and/or for a transparency mode. Additionally or alternatively, the hearable 102 enables the touch-based control 218 at 1108. In particular, the hearable 102 causes the touch-based control 218 to be in the active state 224.

In this example, the operations at 1106 and 1108 can be performed based on the hearable 102 determining that it is not being repositioned using active acoustic sensing. Alternatively, the hearable 102 can perform operations 1106 and/or 1108 based on an expiration of a timer or based on a delay circuit, as described above with respect to FIG. 2-2.

If the hearable 102 determines that it is being adjusted at 1104, operations can continue at 1110 and/or 1112. At 1110, the hearable 102 causes the active-noise-cancellation circuitry 220 and/or the transparency-mode circuitry 222 to operate in accordance with the light mode 230. The light mode 230 enables a second amount of feedback gain (e.g., a second gain) to be applied for active noise cancellation and/or for a transparency mode. The second amount of feedback gain is less than the first amount of feedback gain to mitigate howling. In this way, the hearable 102 can reduce the howling noise heard by the user 106.

Additionally or alternatively, the hearable 102 disables the touch-based control 218 at 1112. In particular, the hearable 102 causes the tough-cased control 218 to be in the inactive state 226. In this way, the user 106 can confidently grip the hearable 102 and easily repositioning it without worrying about inadvertently activating the touch-based control 218.

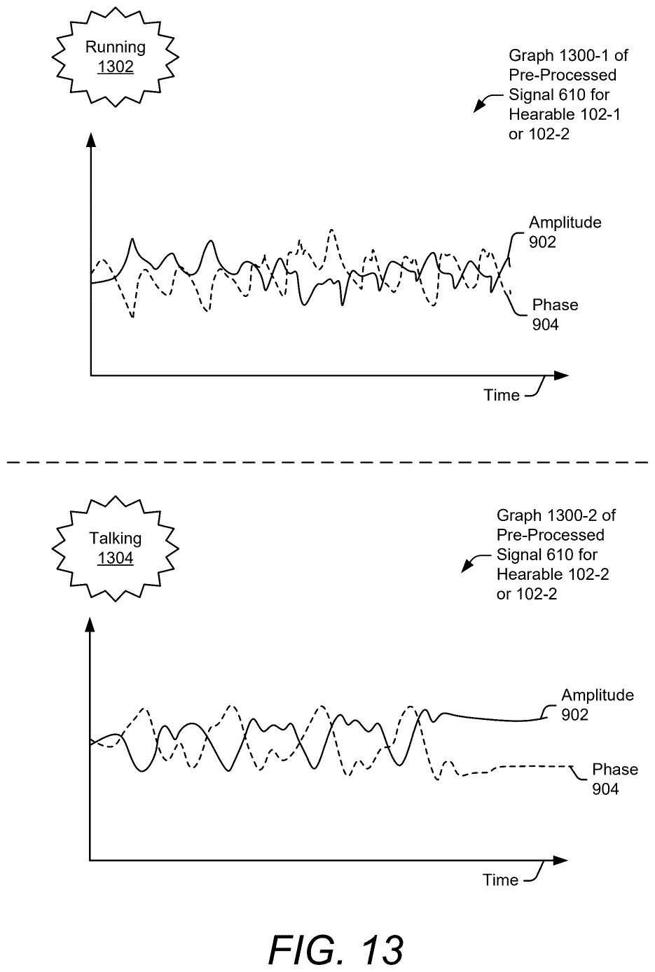

Although not explicitly shown in FIG. 11, the hearable 102 can optionally control an operation of the computing device 104 based on hearable-adjustment detection 114, as described with respect to FIG. 2-2. The hearable 102 can perform hearable-adjustment detection 114 by analyzing the pre-processed signal 610, as further described with respect to FIGS. 12 and 13.

FIG. 12 illustrates impact of the user 106 adjusting the position of the hearable 102. More specifically, FIG. 12 depicts example amplitudes 902 and phases 904 of pre-processed signals 610 generated by hearable 102-1 or 102-2. As shown below, the amplitude 902 and/or the phase 904 of the pre-processed signals 610 can be significantly impacted by the user 106 adjusting the position of the hearable 102. In some instances, the change in the amplitude 902 and/or the phase 904 can be relative to a previous state or relative to a previous trend in the amplitude 902 and/or the phase 904.

In some implementations, the measurement module 420 can perform hearable-adjustment detection 114 based on the amplitude 902 of the pre-processed signal 610 provided by the hearable 102-1, the phase 904 of the pre-processed signal 610 provided by the hearable 102-1, the amplitude 902 of the pre-processed signal 610 provided by the hearable 102-2, the phase 904 of the pre-processed signal 610 provided by the hearable 102-2, or some combination thereof. Generally speaking, processing a larger quantity of signals and/or tones 604 provides more information to the measurement module 420. This can make it easier for the measurement module 420 to accurately perform hearable-adjustment detection 114.

Graphs 1200-1 and 1200-2 in FIG. 12 depict amplitudes 902 and phases 904 of pre-processed signals 610 that are generated by the hearables 102-1 or 102-2. Time is depicted along the horizontal axes of the graphs 1200-1 and 1200-2. During the time interval shown at 1202, the orientation of the hearable 102 changes as the user 106 rotates the hearable 102, as indicated at 214. This causes the amplitude 902 of the pre-processed signal 610 to change significantly relative to a previous stead-state value. Also, the phase 904 of the pre-processed signal 610 fluctuates by a larger amount compared to a previous stead state.

During the time interval shown at 1204 in the graph 1200-2, the insertion depth of the hearable 102 changes as the user 106 pushes the hearable 102 farther into the ear canal 116, as indicated at 216. This causes the amplitude 902 of the pre-processed signal 610 to change significantly relative to a previous steady-state value. Also, the phase 904 of the audioplethysmography signal 514 changes significantly from a previous steady-state value.

As seen in graphs 1200-1 and 1200-2, the hearable 102 can perform hearable-adjustment detection 114 by detecting a change in the amplitude 902 and/or phase 904 of the pre-processed signal 610. A degree to which the amplitude 902 and/or phase 904 varies as the user 106 repositions the hearable 102 is substantially greater compared to a variation caused by normal activity, as further described with respect to FIG. 13.

FIG. 13 illustrates an impact of normal activity. Graphs 1300-1 and 1300-2 depict an amplitude 902 and a phase 904 of pre-processed signal 610 that is generated and analyzed by the hearable 102. The hearable 102 can represent the hearable 102-1 or the hearable 102-2 of FIG. 5. Time is depicted along the horizontal axes of the graphs 1300-1 and 1300-2.

During the time shown in the graph 1300-1, the user 106 is running 1302. The running action can modify the amplitude 902 and/or the phase 904 of the pre-processed signal 610 to some degree. However, the peaks and variations in the amplitude 902 of the pre-processed signal 610 caused by running 1302 (as shown in the graph 1300-1) are substantially smaller than the peaks and variations in the amplitude 902 of the pre-processed signal 610 caused by the orientation change 214 or insertion depth change 216 (as shown in the graphs 1200-1 and 1200-2 of FIG. 12). Also, the variations in the phase 904 of the pre-processed signal 610 caused by running 1302 (as shown in the graph 1300-1 of FIG. 13) are substantially smaller than the variations in the phase 904 of the pre-processed signal 610 caused by the orientation change 214 or insertion depth change 216 (as shown in the graphs 1200-1 and 1200-2 of FIG. 12).

During the time shown in the graph 1300-2, the user 106 is talking 1304. The talking action can modify the amplitude 902 and/or the phase 904 of the pre-processed signal 610 to some degree. However, the amount of variation in the amplitude 902 of the pre-processed signal 610 caused by talking 1304 (as shown in the graph 1300-2 of FIG. 13) is substantially smaller than the variation in the amplitude 902 of the pre-processed signal 610 caused by the orientation change 214 or insertion depth change 216 (as shown in the graphs 1200-1 and 1200-2 of FIG. 12). Also, the variation in the phase 904 of the pre-processed signal 610 caused by talking 1304 (as shown in the graph 1300-2 of FIG. 13) is substantially smaller than the variation in the phase 904 of the pre-processed signal 610 caused by the orientation change 214 or insertion depth change 216 (as shown in the graphs 1200-1 and 1200-2 of FIG. 12). Due to these differences, hearable-adjustment detection 114 using audioplethysmography 110 can readily distinguish between the user 106 intentionally adjusting the hearable 102 and other activities performed by the user 106. In general, the measurement module 420 can use various techniques, including those associated with signal/data processing and/or machine learning, for performing hearable-adjustment detection 114.

Aspects of hearable-adjustment detection 114 can be performed using one hearable 102 (e.g., the hearable 102-1 or 102-2) or multiple hearables 102 (e.g., the hearables 102-1 and 102-2). In general, the hearable 102 can perform hearable-adjustment detection 114 by analyzing changes in the amplitude 902 of the acoustic receive signal 504, changes in the phase 904 of the acoustic receive signal 504, or changes in both the amplitude 902 and phase 904 of the acoustic receive signal 504.

### Example Methods

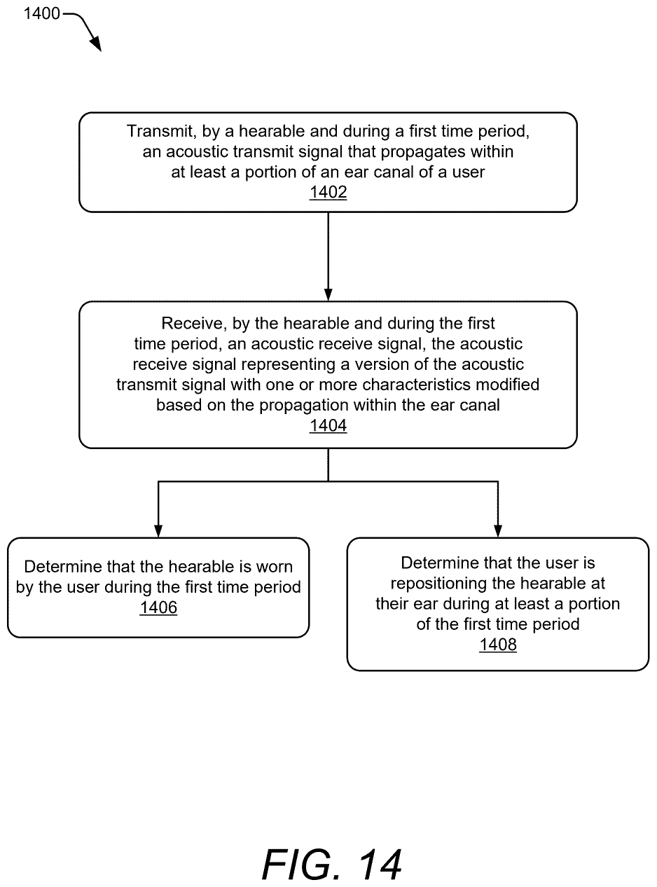

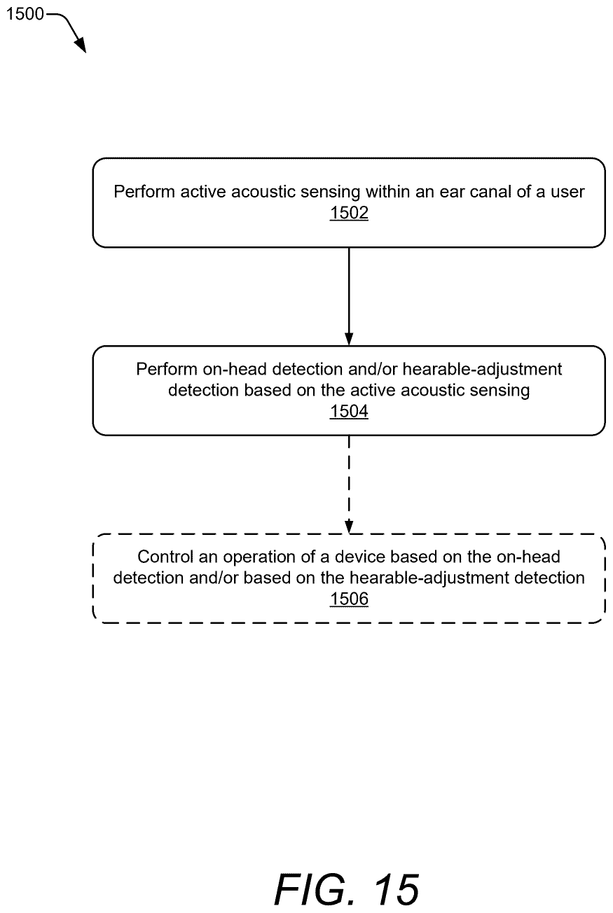

FIGS. 14 and 15 depict example methods 1400 and 1500 for implementing aspects of on-head detection 112 and/or hearable-adjustment detection 114 using active acoustic sensing. Methods 1400 and 1500 are shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environments 100, 200-1, 200-2, 212-1, or 212-2 of FIG. 1, 2-1, or 2-2, and entities detailed in FIGS. 3 and 4, reference to which is made for example only. The techniques are not limited to performance by one entity or multiple entities operating on one device.

At 1402 in FIG. 14, an acoustic transmit signal is transmitted by a hearable during a first time period. The acoustic transmit signal propagates within at least a portion of an ear canal of a user. For example, the transducer 406 (or speaker 408) of the hearable 102 transmits the acoustic transmit signal 502 during the first time period. The acoustic transmit signal 502 propagates within at least a portion of the ear canal 116 of the user 106, as described with respect to FIG. 5.

At 1404, an acoustic receive signal is received by the hearable during the first time period. The acoustic receive signal represents a version of the acoustic transmit signal with one or more characteristics (e.g., waveform characteristics) modified based on the propagation within the ear canal. For example, the transducer 406 (or the microphone 410) of the hearable 102 receives the acoustic receive signal 504 during the first time period. The acoustic receive signal 504 represents a version of the acoustic transmit signal 502 with one or more characteristics modified based on the propagation within the ear canal 116. More specifically, the acoustic receive signal 504 can be modulated by the deformation that occurs within the ear canal 116 as caused by biometrics of the user 106. Additionally or alternatively, the acoustic receive signal 504 can be modulated based on the user 106 adjusting the position of the hearable 102 within their ear 108.

The hearable 102 that receives the acoustic receive signal 504 can be a same hearable 102 that transmitted the acoustic transmit signal 502 (e.g., the hearable 102-1 or 102-2 in FIG. 5), or another hearable 102 that did not transmit the acoustic transmit signal 502 (e.g., the hearable 102-2 in FIG. 5). Example characteristics include amplitude, phase, and/or frequency. In some implementations, a feedback microphone of an active-noise-cancellation circuit 424 can receive the acoustic receive signal 504.

Optionally at 1406, the hearable is determined to be worn by the user during the first time period. For example, the measurement module 420 determines that the hearable 102 is worn by the user 106 during the first time period. In particular, the measurement module 420 can determine that on-head detection 112 is “true” based on a detection (or based on a measurement) of at least one biometric of the user 106's. In some cases, the measurement module 420 can further determine that the on-head detection 112 is “true” based on a measurement value of the biometric being within a valid range, as indicated at 810 in FIG. 8. Alternatively, if the measurement module 420 does not detect a biometric of the user 106 or the measured value of the biometric is outside of the valid range, the on-head detection 112 is determined to be “false,” as indicated at 806 in FIG. 8.

Optionally at 1408, the user is determined to be repositioning the hearable at their ear during at least a portion of the first time period. For example, the measurement module 420 determines that the user 106 is repositioning the hearable 102 at their ear 108 (e.g., repositioning the hearable 102 within their ear 108 or repositioning the hearable 102 while the hearable 102 is being worn) during at least a portion of the first time period. In particular, the measurement module 420 can determine that hearable-adjustment detection is “true” based on occurrence of a significant change in an amplitude 902 and/or a phase 904 of the pre-processed signal 610. Alternatively, if the measurement module 420 does not detect a significant change in the amplitude 902 and/or the phase 904 of the pre-processed signal 610, the hearable-adjustment detection is determined to be “false.” The measurement module 420 can generate a control signal 612 that changes an operation of the hearable 102 and/or changes an operation of the computing device 104 based on the on-head detection 112 at 1406 and/or based on the hearable-adjustment detection 114 at 1408.

At 1502 in FIG. 15, active acoustic sensing is performed within an ear canal of the user. For example, the hearable 102 performs active acoustic sensing within the ear canal 116 of the user 106. More specifically, the hearable 102 transmits and receives an acoustic signal during the first time period. The acoustic signal propagates within at least a portion of the ear canal 116 of the user 106. The received acoustic signal (e.g., the acoustic receive signal 504) represents a version of the transmitted acoustic signal (e.g., the acoustic transmit signal 502) with one or more characteristics (e.g., amplitude 902 and/or phase 904) modified based on the propagation within the ear canal 116.

At 1504, the on-head detection and/or hearable-adjustment detection is performed based on the active acoustic sensing. For example, the measurement module 420 can perform on-head detection 112 and/or hearable-adjustment detection 114 based on the pre-processed signal 610, which is a signal derived from the acoustic receive signal 504.

At 1506, an operation of a device is controlled based on the on-head detection and/or based on the hearable-adjustment detection. For example, the hearable 102 controls an operation of a device based on whether on-head detection 112 is determined to be true or false and/or based on whether hearable-adjustment detection 114 is determined to be true or false. The device can represent the hearable 102 and/or the computing device 104.

### Example Computing System

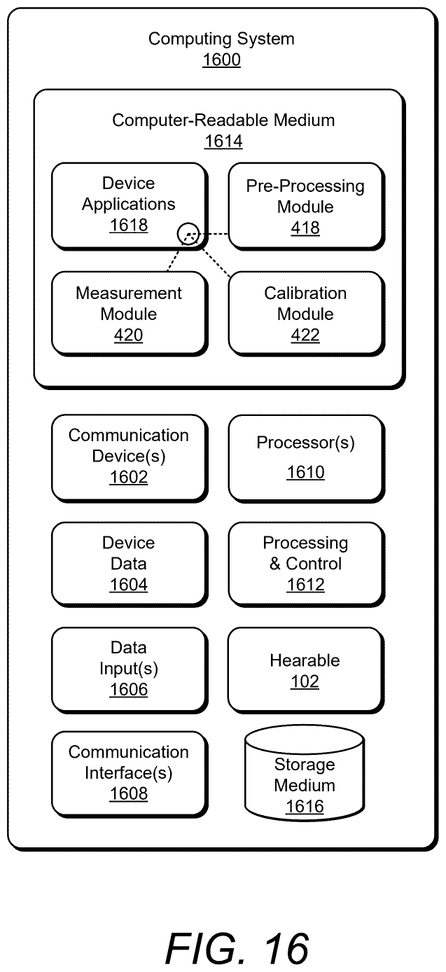

FIG. 16 illustrates various components of an example computing system 1600 that can be implemented as any type of client, server, and/or computing device as described with reference to the previous FIGS. 3 and 4 to implement aspects of active acoustic sensing using a hearable 102. The computing system 1600 includes communication devices 1602 that enable wired and/or wireless communication of device data 1604 (e.g., received data, data that is being received, data scheduled for broadcast, or data packets of the data). The communication devices 1602 or the computing system 1600 can include one or more hearables 102. The device data 1604 or other device content can include configuration settings of the device, media content stored on the device, and/or information associated with a user of the device. Media content stored on the computing system 1600 can include any type of audio, video, and/or image data. The computing system 1600 includes one or more data inputs 1606 via which any type of data, media content, and/or inputs can be received, such as human utterances, user-selectable inputs (explicit or implicit), messages, music, television media content, recorded video content, and any other type of audio, video, and/or image data received from any content and/or data source.

The computing system 1600 also includes communication interfaces 1608, which can be implemented as any one or more of a serial and/or parallel interface, a wireless interface, any type of network interface, a modem, and as any other type of communication interface. The communication interfaces 1608 provide a connection and/or communication links between the computing system 1600 and a communication network by which other electronic, computing, and communication devices communicate data with the computing system 1600.

The computing system 1600 includes one or more processors 1610 (e.g., any of microprocessors, controllers, and the like), which process various computer-executable instructions to control the operation of the computing system 1600. Alternatively or in addition, the computing system 1600 can be implemented with any one or combination of hardware, firmware, or fixed logic circuitry that is implemented in connection with processing and control circuits which are generally identified at 1612. Although not shown, the computing system 1600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1600 also includes a computer-readable medium 1614, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 1600 can also include a mass storage medium device (storage medium) 1616.

The computer-readable medium 1614 provides data storage mechanisms to store the device data 1604, as well as various device applications 1618 and any other types of information and/or data related to operational aspects of the computing system 1600. For example, an operating system 1620 can be maintained as a computer application with the computer-readable medium 1614 and executed on the processors 1610. The device applications 1618 may include a device manager, such as any form of a control application, software application, signal-processing and control module, code that is native to a particular device, a hardware abstraction layer for a particular device, and so on.

The device applications 1618 also include any system components, engines, or managers to implement audioplethysmography 110 for on-head detection 112 and/or for hearable-adjustment detection 114. In this example, the device applications 1618 include the pre-processing module 418, the measurement module 420, and optionally includes the calibration module 422. Although not explicitly shown, the device applications 1618 can also include the application 306.

Throughout this disclosure, examples are described where a computing system 1600 (e.g., the hearable 102, the computing device 104, a client device, a server device, a computer, or another type of computing system) may analyze information (e.g., various audible and/or acoustic signals) associated with a user 106, for example, the pre-processed signal 610 mentioned with respect to FIG. 6. Further to the descriptions above, a user 106 may be provided with controls allowing the user 106 to make an election as to both if and when systems, programs, and/or features described herein may enable collection of information (e.g., information associated with on-head detection 112, information associated with hearable-adjustment detection 114, biometrics of the user 106, information about a user 106's social network, social actions, social activities, profession, a user 106's preferences, a user 106's current location), and if the user 106 is sent content or communications from a server. The computing system 1600 can be configured to only use the information after the computing system 1600 receives explicit permission from the user 106 to use the data. For example, in situations where the hearable 102 analyzes signals for on-head detection 112 and/or hearable-adjustment detection 114, individual users 106 may be provided with an opportunity to provide input to control whether programs or features of the computing system 1600 can collect and make use of the data. Further, individual users 106 may have constant control over what programs can or cannot do with the information.

In addition, information collected may be pre-treated in one or more ways before it is transferred, stored, or otherwise used, so that personally-identifiable information is removed. For example, before the computing system 1600 shares data with another device, a user 106's identity may be treated so that no personally identifiable information can be determined for the user 106. Thus, the user 106 may have control over whether information is collected about the user 106 and the user 106's device, and how such information, if collected, may be used by the computing system 1600 and/or a remote computing system.

### CONCLUSION

Although techniques using, and apparatuses including, on-head detection and/or hearable-adjustment detection using active acoustic sensing have been described in language specific to features and/or methods, it is to be understood that the subject of the appended examples is not necessarily limited to the specific features or methods described. Rather, the specific features and methods are disclosed as example implementations of on-head detection and/or hearable-adjustment detection using active acoustic sensing.

Some examples are provided below.

Example 1: A method comprising:
transmitting, by a hearable and during a first time period, an acoustic transmit signal that propagates within at least a portion of an ear canal of a user;
receiving, by the hearable and during the first time period, an acoustic receive signal, the acoustic receive signal representing a version of the acoustic transmit signal with one or more characteristics modified based on the propagation within the ear canal; and
determining, based on the acoustic receive signal, at least one of the following:
   that the hearable is worn by the user during the first time period; and/or
   that the user is repositioning the hearable at their ear during at least a portion of the first time period.

Example 2: The method of example 1, further comprising:
generating a control signal that controls an operation of a device based on the determination that the hearable is worn by the user and/or based on the determination that the user is repositioning the hearable.

Example 3: The method of example 2, wherein the device comprises the hearable.

Example 4: The method of example 3, wherein:
generating the control signal comprises generating the control signal based on the determination that the hearable is worn by the user; and
the method further comprises:
   operating the hearable in accordance with a low-power mode prior to the determination that the hearable is worn by the user; and
   causing, based on the control signal, the hearable to operate in accordance with a high-power mode, the high-power mode associated with a larger amount of power consumption compared to the low-power mode.

Example 5: The method of example 3, wherein:
generating the control signal comprises generating the control signal based on the determination that the user is repositioning the hearable; and
the method further comprises at least one of the following:
   causing, based on the control signal, a touch-based control function of the hearable to transition from an active state to an inactive state;
   causing, based on the control signal, active-noise-cancellation circuitry of the hearable to transition from a normal mode to a light mode for active noise cancellation; and
   causing, based on the control signal, transparency-mode circuitry of the hearable to transition from a normal mode to a light mode for a transparency mode of the hearable.

Example 6: The method of example 2, wherein the device comprises a computing device that is coupled to the hearable.

Example 7: The method of example 6, wherein:
generating the control signal comprises generating the control signal based on the determination that the hearable is worn by the user; and
the method further comprises:
   causing, based on the control signal, the computing device to transition from playing audio content using a speaker of the computing device to providing the audio content to the hearable.

Example 8: The method of example 7, further comprising:
transmitting, by the hearable and during a second time period, another acoustic transmit signal;
receiving, by the hearable and during the second time period, another acoustic receive signal; and
determining, based on the other acoustic receive signal, that the hearable is not worn by the user during the second time period.

Example 9: The method of example 8, further comprising:
generating another control signal based on the determination that the hearable is not worn by the user; and
causing, based on the other control signal, the computing device to transition from providing the audio content to the hearable to playing the audio content using the speaker of the computing device.

Example 10: The method of any previous example, further comprising:
detecting at least one biometric of the user based on the acoustic receive signal; and
wherein determining that the hearable is worn by the user comprises determining that the hearable is worn by the user based on the detection of the at least one biometric.

Example 11: The method of example 10, wherein determining that the hearable is worn by the user comprises:
determining that a measured value of the at least one biometric is within a valid range; and
determining that the hearable is worn by the user based on the determination that the measured value of the at least one biometric is within the valid range.

Example 12: The method of example 10 or 11, wherein detecting the at least one biometric comprises detecting, based on the acoustic receive signal, at least one of a heart rate or a respiration rate of the user.

Example 13: The method of example 12, wherein detecting at least one of the heart rate or the respiration rate of the user comprises:
demodulating the acoustic receive signal by mixing a digital version of the acoustic receive signal with a digital version of the acoustic transmit signal to generate a mixed signal;
passing the mixed signal through a low-pass filter to generate a filtered signal;
generating an autocorrelation of the filtered signal; and
measuring a periodicity of the autocorrelation of the filtered signal to determine the heart rate or the respiration rate.

Example 14: The method of any previous example, wherein determining that the user is repositioning the hearable comprises determining that the user is adjusting a position and/or an orientation of the hearable relative to the ear of the user based on the acoustic receive signal.

Example 15: The method of example 14, wherein determining that the user is adjusting the position and/or the orientation of the hearable comprises detecting a change in at least one of an amplitude or a phase of a signal that is derived from the acoustic receive signal.

Example 16: Anon-transitory computer-readable storage medium comprising instructions that, responsive to execution by a processor, cause a hearable to perform any one of the methods of examples 1 to 15.

Example 17: A system comprising:
at least one transducer; and
at least one processor, the system configured to perform, using the at least one transducer and the at least one processor, any one of the methods of examples 1 to 15.

Example 18: The system of example 17, further comprising:
a speaker; and
an active-noise-cancellation circuit comprising a feedback microphone, wherein the at least one transducer comprises the speaker and the feedback microphone.

Example 19: The system of example 17, wherein:
the at least one transducer comprises a speaker and a microphone;
the speaker is configured to be positioned proximate to a first ear of a user; and
the microphone is configured to be positioned proximate to a second ear of the user.

Example 20: The system of any one of examples 17 to 19, wherein the system comprises at least one earbud, the at least one earbud comprising the at least one transducer and the at least one processor.

1. A method comprising:
transmitting, by a hearable and during a first time period, acoustic transmit signals that propagate within at least a portion of an ear canal of a user;
receiving, by the hearable and during the first time period, acoustic receive signals, the acoustic receive signals representing versions of the acoustic transmit signals with one or more characteristics modified based on the propagation within the ear canal; and
determining, based on at least one of an amplitude or a phase of the acoustic receive signals, at least one of the following:
that the hearable is worn by the user during the first time period; and
while the hearable is worn by the user, that the user is repositioning the hearable at their ear during at least a portion of the first time period.

2. The method of claim 1, further comprising:
generating a control signal that controls an operation of a device based on the determination that the hearable is worn by the user and/or based on the determination that the user is repositioning the hearable.

3. The method of claim 2, wherein the device comprises the hearable.

4. The method of claim 3, wherein:
generating the control signal comprises generating the control signal based on the determination that the hearable is worn by the user; and
the method further comprises:
operating the hearable in accordance with a low-power mode prior to the determination that the hearable is worn by the user; and
causing, based on the control signal, the hearable to operate in accordance with a high-power mode, the high-power mode associated with a larger amount of power consumption compared to the low-power mode.

5. The method of claim 3, wherein:
generating the control signal comprises generating the control signal based on the determination that the user is repositioning the hearable; and
the method further comprises at least one of the following:
causing, based on the control signal, a touch-based control function of the hearable to transition from an active state to an inactive state;
causing, based on the control signal, active-noise-cancellation circuitry of the hearable to transition from a normal mode to a light mode for active noise cancellation; and
causing, based on the control signal, transparency-mode circuitry of the hearable to transition from a normal mode to a light mode for a transparency mode of the hearable.

6. The method of claim 2, wherein the device comprises a computing device that is coupled to the hearable.

7. The method of claim 6, wherein:
generating the control signal comprises generating the control signal based on the determination that the hearable is worn by the user; and
the method further comprises:
causing, based on the control signal, the computing device to transition from playing audio content using a speaker of the computing device to providing the audio content to the hearable.

8. The method of claim 7, further comprising:
transmitting, by the hearable and during a second time period, another acoustic transmit signal;
receiving, by the hearable and during the second time period, another acoustic receive signal; and
determining, based on the other acoustic receive signal, that the hearable is not worn by the user during the second time period.

9. The method of claim 8, further comprising:
generating another control signal based on the determination that the hearable is not worn by the user; and
causing, based on the other control signal, the computing device to transition from providing the audio content to the hearable to playing the audio content using the speaker of the computing device.

10. The method of claim 1, further comprising:
detecting at least one biometric of the user based on an acoustic receive signal; and
wherein determining that the hearable is worn by the user comprises determining that the hearable is worn by the user based on the detection of the at least one biometric.

11. The method of claim 10, wherein determining that the hearable is worn by the user comprises:
determining that a measured value of the at least one biometric is within a valid range; and
determining that the hearable is worn by the user based on the determination that the measured value of the at least one biometric is within the valid range.

12. The method of claim 10, wherein detecting the at least one biometric comprises detecting, based on the acoustic receive signal, at least one of a heart rate or a respiration rate of the user.

13. The method of claim 12, wherein detecting at least one of the heart rate or the respiration rate of the user comprises:
demodulating the acoustic receive signal by mixing a digital version of the acoustic receive signal with a digital version of the acoustic transmit signal to generate a mixed signal;
passing the mixed signal through a low-pass filter to generate a filtered signal;
generating an autocorrelation of the filtered signal; and
measuring a periodicity of the autocorrelation of the filtered signal to determine the heart rate or the respiration rate.

14. The method of claim 1, wherein determining that the user is repositioning the hearable comprises determining that the user is adjusting a position and/or an orientation of the hearable relative to the ear of the user based on an acoustic receive signal.

15. The method of claim 14, wherein determining that the user is adjusting the position and/or the orientation of the hearable comprises detecting a change in at least one of an amplitude or a phase of a signal that is derived from the acoustic receive signal.

16. A non-transitory computer-readable storage medium comprising instructions that, responsive to execution by a processor, cause a hearable to:
transmit during a first time period, acoustic transmit signals that propagate within at least a portion of an ear canal of a user;
receive, during the first time period, acoustic receive signals, the acoustic receive signals representing versions of the acoustic transmit signals with one or more characteristics modified based on the propagation within the ear canal; and
determine, based on at least one of an amplitude or a phase of the acoustic receive signals, at least one of the following:
that the hearable is worn by the user during the first time period; and
while the hearable is worn by the user, that the user is repositioning the hearable at their ear during at least a portion of the first time period.

17. A system comprising:
at least one transducer configured to:
transmit, during a first time period, acoustic transmit signals that propagate within at least a portion of an ear canal of a user; and
receive, during the first time period, acoustic receive signals, the acoustic receive signals representing versions of the acoustic transmit signals with one or more characteristics modified based on the propagation within the ear canal; and
at least one processor coupled to the at least one transducer and configured to:
determine, based on at least one of an amplitude or a phase of the acoustic receive signals, at least one of the following:
that the system is worn by the user during the first time period; and
while the system is worn by the user, that the user is repositioning the system at their ear during at least a portion of the first time period.

18. The system of claim 17, further comprising:
a speaker; and
an active-noise-cancellation circuit comprising a feedback microphone,
wherein the at least one transducer comprises the speaker and the feedback microphone.

19. The system of claim 17, wherein:
the at least one transducer comprises a speaker and a microphone;
the speaker is configured to be positioned proximate to a first ear of a user; and
the microphone is configured to be positioned proximate to a second ear of the user.

20. The system of claim 17, wherein the system comprises at least one earbud, the at least one earbud comprising the at least one transducer and the at least one processor.
